(19) United States
(12) Patent Application Publication
(10) Pub. No.: US 2012/0101891 A1
(43) Pub. Date: Apr. 26, 2012

(54) CAR PRICING AND PURCHASING SYSTEM AND METHOD

(76) Inventors: Chadwick J. Collier, Collierville, TN (US); Ronald L. Collier, Collierville, TN (US)

(21) Appl. No.: 13/235,229

(22) Filed: Sep. 16, 2011

Related U.S. Application Data
(60) Provisional application No. 61/384,018, filed on Sep. 17, 2010.

(51) Int. Cl. G06Q 30/02

(52) U.S. Cl. 705/14.34; 705/26.1; 705/14.4

(57) ABSTRACT

Various embodiments are directed to a customer computer device for facilitating the purchase of products comprising at least one processor and operatively associated memory. The device may capture a product identifier from an instance of a product. The product identifier may indicate a first instance of the product. The device may also transmit the product identifier to a service provider system and receive from the service provider system a rebated sales price for the first instance of the product. The rebated sales price may reflect an invoice price of the product, a deduction to the invoice price, and at least one rebate offered by the manufacturer of the product. Additionally, the device may provide the rebated sales price to a customer via a graphical user interface.

### PRIORITY CLAIM

This application claims the benefit of U.S. Provisional Application Ser. No. 61/384,018 filed on Sep. 17, 2010, which is incorporated herein by reference in its entirety.

### BACKGROUND

Cars and other big-ticket retail products, such as motorcycles, recreational vehicles, etc., are currently priced and sold on the basis of negotiations between dealers and customers. Products are marked with an asking price, which for new cars is often the manufacturer suggested retail price (MSRP). Customers and dealers agree to a sales price that is typically less than the asking price. Many factors affect the sales price including the negotiating skills of the consumer, trim level and options included with the product, manufacturer rebates, etc. During and after negotiations, it is difficult for customers to know whether a dealer is offering their best price, let alone a fair price. Customers may doubt their negotiating skills. Further, the negotiation process is often arduous and time consuming. Customers may not want to spend their time engaging in back-and-forth negotiations with a salesperson about the price of a car.

As can be seen, there is a need for a system and method for allowing a consumer to receive an upfront car price quote from a dealer through an automated system verified by a third party.

### SUMMARY

Various embodiments are directed to systems and methods for facilitating the sale and/or purchase of retail products such as cars, motorcycles, recreational vehicles (RV's), etc. Many of the examples herein are described in the context of car sales, however, it will be appreciated that the systems and methods described may be applied to the sale of any retail product.

### DRAWINGS

FIG. 1 is a diagram showing one embodiment of a process flow for facilitating product purchases.

FIG. 2 is a representation showing one embodiment of a sign-in screen for signing into a car pricing application in a smart phone.

FIG. 3 is a representation showing one embodiment of a dealer locator screen in the car pricing application of FIG. 2.

FIG. 4 is a representation showing one embodiment of a dealer locator map screen in the car pricing application of FIG. 2.

FIG. 5 is a representation showing one embodiment of a dealer check-in screen in the car pricing application of FIG. 2.

FIG. 6 is a representation showing one embodiment of a user scanning a VIN code, with their smart phone, into the car pricing application of FIG. 2.

FIG. 7 is a representation showing one embodiment of a car pricing screen in the car pricing application of FIG. 2.

FIG. 8 is a representation showing one embodiment of a continuation of the car pricing screen of FIG. 7.

FIG. 9 is a representation showing one embodiment of a user interface sign-in screen for signing into a product pricing application on customer device.

FIG. 10 is a representation showing one embodiment of a user interface screen providing information about a product.

FIG. 11 is a representation showing one embodiment of a user interface screen providing information about multiple types of products.

FIG. 12 is a representation showing one embodiment of a user interface screen providing an expert assistance feature.

FIG. 13 is a representation showing one embodiment of a user interface screen providing a dealer location feature.

FIG. 14 is a representation showing one embodiment of a user interface screen providing detailed dealer information.

FIG. 15 is a representation showing one embodiment of a user interface screen providing an incentive/rebate selection feature.

FIG. 16 is a representation showing another embodiment of the car pricing screen of FIG. 7.

FIGS. 16A and 16B are representations showing one embodiment of a user interface screen for comparing properties of selected products.

FIGS. 16C and 16D are representations showing one embodiment of another user interface for comparing properties of selected products.

FIG. 17 is a block diagram showing one embodiment of an environment for facilitating product purchases.

FIG. 18 is a diagram showing one embodiment of a process flow for facilitating product purchases.

FIG. 19 is a diagram showing another embodiment of the process flow of FIG. 18 including finance support.

FIG. 20 a screen shot showing one embodiment of a summary screen of the dealer interface.

FIG. 21 is a screen shot showing one embodiment of a customer information screen of the dealer interface.

FIG. 22 is a screen shot showing one embodiment of a customer summary screen of the dealer interface.

FIG. 23 is a screen shot showing one embodiment of a message screen of the dealer interface.

FIG. 24 is a screen shot showing one embodiment of a message displayed through the dealer interface.

FIG. 25 is a screen shot showing one embodiment of a Quote Request screen.

FIG. 26 is a screen shot showing one embodiment of a quote summary screen of the dealer interface.

FIG. 27 is a diagram showing one embodiment of a process flow for facilitating communication between dealers and potential customers, for example, utilizing the dealer interface.

FIG. 28 is a diagram showing another embodiment of a process flow for facilitating communication between dealers and potential customers, for example, utilizing the dealer interface.

### DESCRIPTION

In various embodiments, a service provider generates and distributes pricing information's for particular products. The pricing information's may be provided to potential customers of the products. For example, when the products are cars, pricing information may reflect a price for a particular vehicle identification number (VIN). To generate the pricing information, the service provider may apply an offset to a product's invoice price. The invoice price may roughly correspond to the price paid by the dealer to purchase the product (e.g., from the manufacturer). In some case, the invoice price may not reflect the dealer's actual cost to obtain the product, for example, due to floor plan costs, holdbacks, factory-to-dealer incentives, sales bonuses, etc. The offset represents the lowest margin that a dealer is willing to accept for a product above or below the invoice price. Offsets may be dealer-specific and, in some cases, may be dealer and product specific. For example, car dealers may agree to different offsets for different models. In some embodiments, values for offsets may be set by negotiations between the service provider and dealers of the product. Also, in some cases, the values for offsets may be set by negotiations between a price setting party and the dealers. In these embodiments, the service provider may receive the offsets from the price setting party, either in bulk or on a request-by-request basis. In addition to applying the offset, the service provider may, in some embodiments, apply one or more direct-to-customer rebates or incentives.

The service provider may generate and distribute pricing information's utilizing a price service computer system in communication with a plurality of customer devices. The computer system may make one or more price service applications or “apps” available to customers. Customers may execute the apps on their customer devices. When a customer is present at a participating dealer (or other location of the product), the customer may use the customer device to input an identifier of a particular instance of the product (e.g., a VIN number). The app/customer device may transmit the identifier to the price service computer system. Upon receiving the identifier, the price service computer system may retrieve the invoice price, for example, from a dealer computer system and any available rebates or incentives, for example, from a manufacturer computer system. The offset may be applied to generate a sales price. Any available customer rebates and/or incentives may then be applied to the sales price to generate a rebated sales price. The pricing information provided to the customer may comprise the sales price, the rebated sales price, or both.

In addition to, or instead of the pricing information feature described above, the app/customer device may be used to deliver various other customer services. For example, the app/customer device may be used to provide customers and potential customers with product information including, for example, model specifications, images, videos, reviews, etc. Requests for such information may be made through the service provider system, which may retrieve the information from an internal data store and/or from a third party source. Also, for example, the app/customer device may be used to indicate dealer locations to customers. For example, when a customer utilizes the app/customer device, it may be transmit a position of the customer device to the service provider system. The service provider system may respond by providing the customer device with indications of product dealers located near the customer device's location.

Also, in some embodiments, the service provider may implement a dealer user interface for facilitating communication between product dealers and potential customers. Such an interface may be provided with or without the pricing information feature described above. The dealer interface may leverage customer data received through the pricing information feature and/or other customer services. Through the interface, a dealer may receive an indication of potential customers that may be interested in the dealer's products. For example, the dealer may receive an indication of customers who have searched and/or requested pricing information's for products (e.g., car models) that the dealer stocks. The indication may include various information about the potential customer including, for example, products for which the customer has requested information or a sales quote, a current or recent position of the customer, etc. In some embodiments the dealer interface may comprise a graphical map, with individual potential customers indicated as markers on the map. The interface may also provide the dealers with functionality for sending messages to individual potential customers through the apps and associated customer devices. For example, a dealer may identify a potential customer and provide advertisements, promotions, or other information to the customer through the interface.

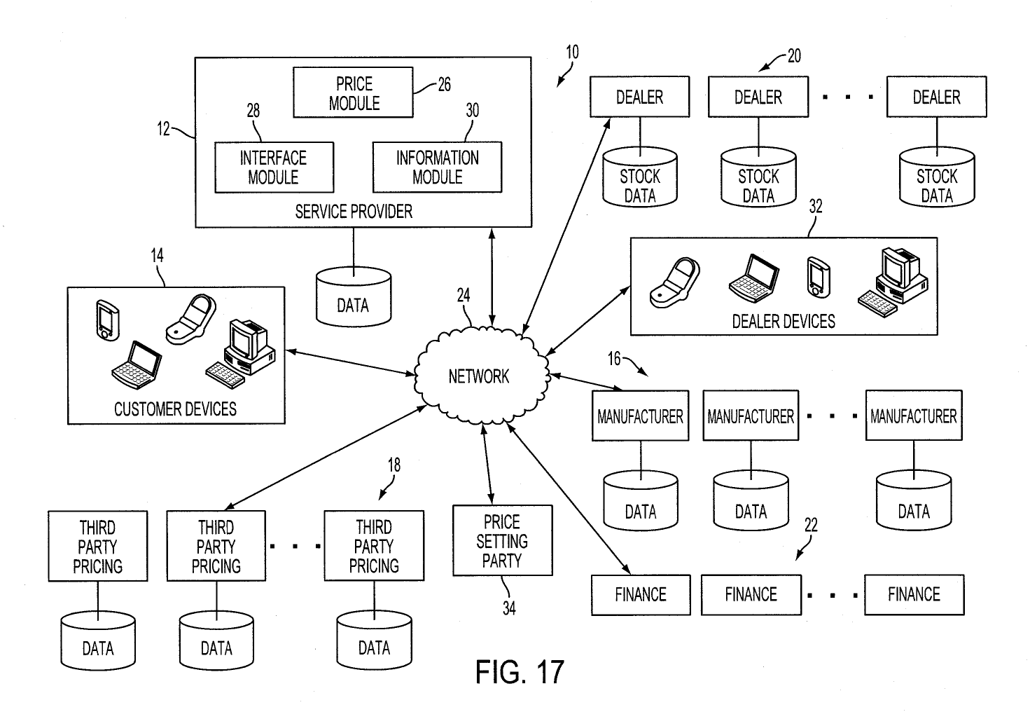

FIG. 17 is a block diagram showing one embodiment of an environment 10 for facilitating product purchases. The environment 10 comprises a service provider system 12 and may optionally include various other systems such as, for example, customer devices 14, dealer devices 32, manufacturer systems 16, third party pricing system 18, dealer systems 20, and finance systems 22. The various systems and devices of the environment 10 may be and/or comprise computers or other processing devices executing software for performing various actions, as described herein. For example, the customer devices 14 may be any type of device used by a customer or potential customer to execute an app or apps, as described, and receive data regarding products. Example customer devices 14 may include any type of personal processing device including, for example, mobile telephones, tablet computers, laptop computers, desktop computers, etc. Dealer devices 32 may be any type of computer or other processing device used by a dealer or representative of a dealer to access the service provider system 12. For example, dealer devices 32 may be utilized to access the dealer interface described herein. In some embodiments, dealer devices 32 and dealer systems 22 may be one and the same and/or may share components.

Manufacturer systems 16 may be implemented by product manufacturers and may provide data regarding products including, for example, rebate and incentive data used for determining pricing information, product specifications and images, etc. Third party pricing systems 18 may be implemented by third parties that track product pricing. Dealer systems 20 may be implemented by product dealers. Finance systems 22 may be implemented by finance providers (e.g., banks or other financial institutions that can completely or partially finance a purchase of a product). Optional price setting party system 34 may be implemented by parties, other than the service provider, that may negotiate offsets with the dealers. The various systems 12, 14, 16, 18, 20, 22, 34 may communicate with one another via a network 24. The network 24 may include any suitable combination of wired and/or wireless connections including, for example local area networks (LAN's), and/or wide area networks (WAN's) such as the Internet.

Optionally, the service provider system 12 may execute multiple software modules for performing different tasks. A price module 26 may implement a product pricing information service, as described herein. An information module 30 may implement a service for providing product information to customers and potential customers. An interface module 28 may implement the dealer interface described herein, as well as other interfaces (e.g., for administrative access, etc.).

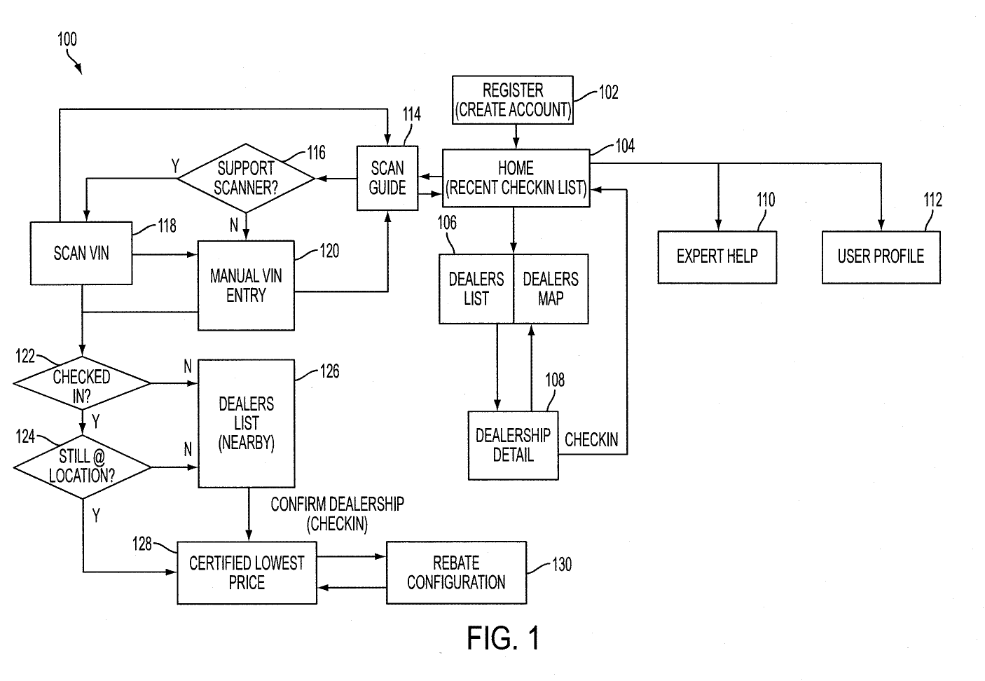

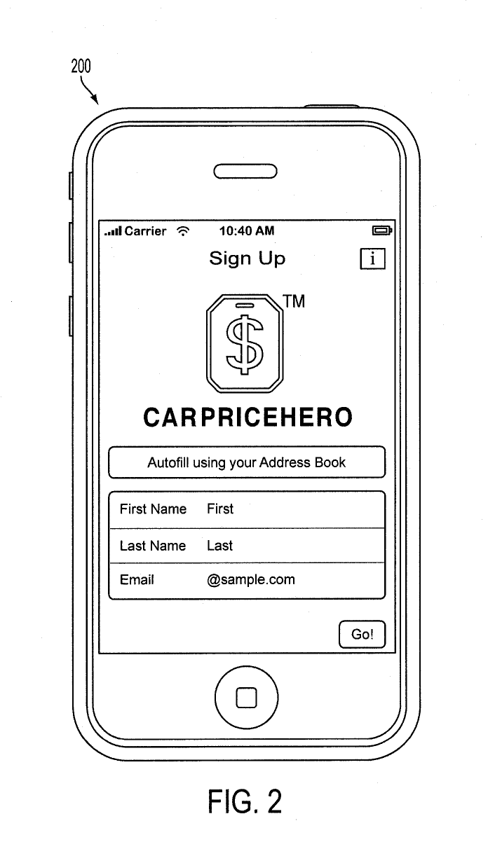

FIG. 1 is a diagram showing one embodiment of a process flow 100 for facilitating product purchases. Specifically, the process flow 100 describes deriving and providing pricing information to a customer device 14. In various embodiments, the process flow 100 may be executed by the service provider system 12, for example, by the price module 26 of the service provider system 12. At state 102, the customer device may register with the service provider system 12. Registration may involve downloading the app from a data store associated with the service provider system 12 or from a third party source (e.g., the APPLE APP STORE, the ANDROID MARKET, etc.). Registration may also involve providing certain customer registration information to the system 12 via a user interface provided through the app. For example, FIG. 2 is a representation showing one embodiment of a sign-in screen 200 for registering a car pricing application, such as the app, at a customer device 14. The screen 200 may be served to a customer device 14, for example, by the service provider system 12. As shown in FIG. 2, registration information may comprise the name and e-mail address of the customer. In some embodiments, the registration information may also comprise a hardware identifier of the customer device 14, such as a subscriber identity module (SIM) number, a unique device identifier (UDID), etc. The hardware identifier may be used, for example, to disclose customer information to dealer systems 20 without also disclosing the identity of the customer. Registration information may also comprise location information including, for example, a home location for the customer provided as an address or as a latitude and longitude (e.g., from application of a global position system, triangulation method, etc.).

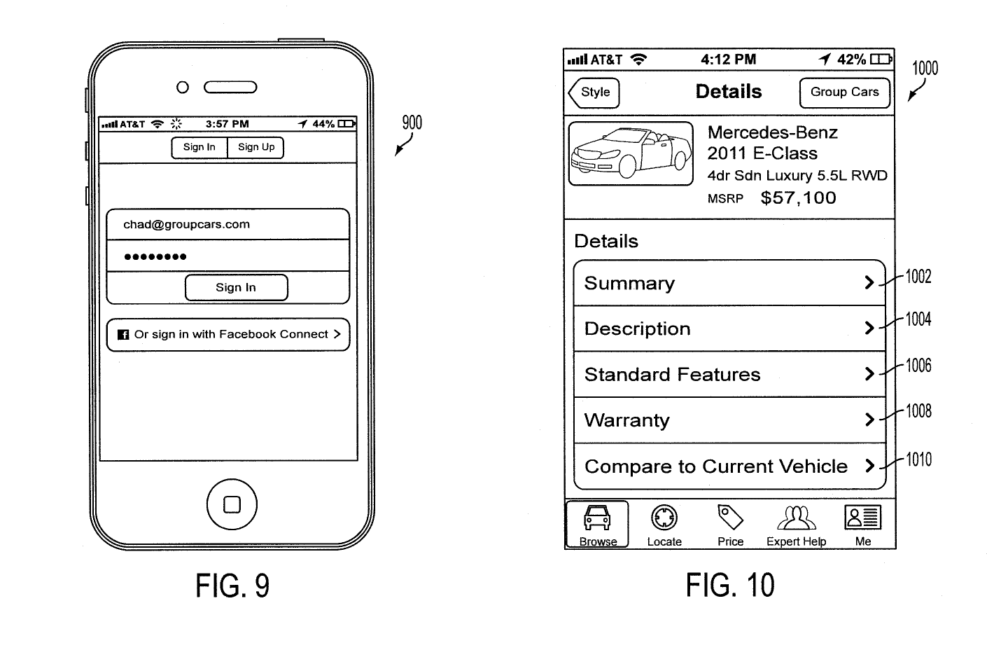

Referring again to FIG. 1, the app/customer device 14 may proceed to a home state 104. In the home state 104, customer may sign-in to the app/customer device 14 and/or the service provider system 12. For example, the customer may authenticate him or herself with a user name and password. FIG. 9 is a representation showing one embodiment of a user interface sign-in screen 900 for signing into a product pricing app on customer device 14. As illustrated in FIG. 9, the customer may provide a user name (here an e-mail address) and password, which may be transmitted by the customer device 14 to the service provider system 12 to authenticate the customer. In some embodiments, the customer may sign onto and/or access the app through a social media and/or social publishing site such as, for example, FACEBOOK, TWITTER, MYSPACE, etc. In conjunction with the sign in process, some embodiments of the app will also cause the customer device 14 to provide the service provider system 12 with a location of the customer device 14. The location can either be a home location of the customer or a current location of the customer (e.g., as measured by the customer device). The current and/or home location may be measured by the customer device 14 using any suitable method. For example, a home location may be found based on address information provided by the customer. A current location may be found using any suitable technology including, for example, global positions systems (GPS), tower triangulation, etc.

Also in the home state 104, the app/customer device 14 may provide the customer with access to an expert help state 110. Expert help may be provided in the form of frequently asked questions, live human support, and/or offline human support. For example, FIG. 12 is a representation showing one embodiment of a user interface screen 1200 that may be shown to a customer to provide an expert assistance feature. The screen 1200 includes expert fields 1202, 1204, 1206 showing and describing experts that are available for online and/or offline communication. Optionally, the respective fields 1202, 1204, 1206, 1208, may include a description of each expert's area of expertise as well as a button 1208, 1210 for contacting the respective expert through the app/customer device 14. For example, customers may choose the expert with whom they would like to correspond. Experts that are online may be contacted, for example, by initiating a call through the customer device 14 (by selecting a respective Call button 1208) or other device. Experts that are off-line may be contacted, for example, by sending an e-mail through the customer device 14 (by selecting a respective Email button 1210) or through another device. In addition, at the home state 104, for example, the customer may have access to the customer's user profile at user profile state 112. For example, the customer may provide user information making up the profile as shown in FIG. 2. Also, for example, the customer may modify customer information including, for example, login and password information, home locations, etc.

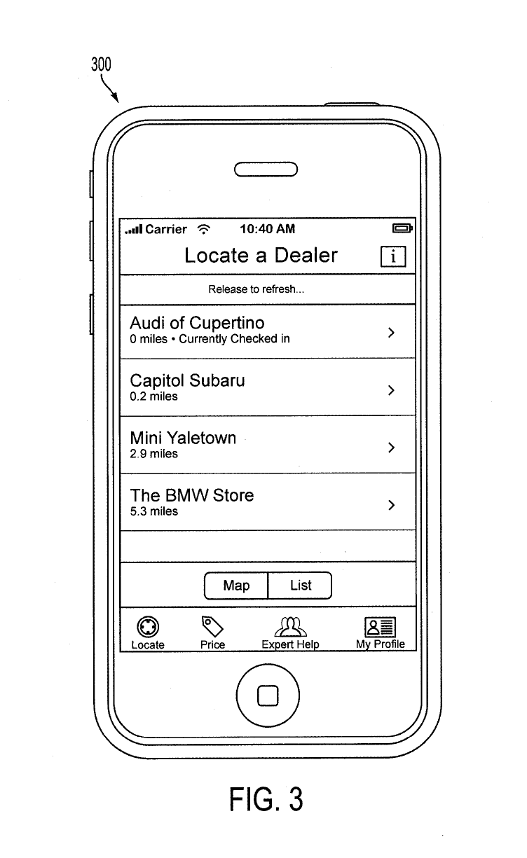

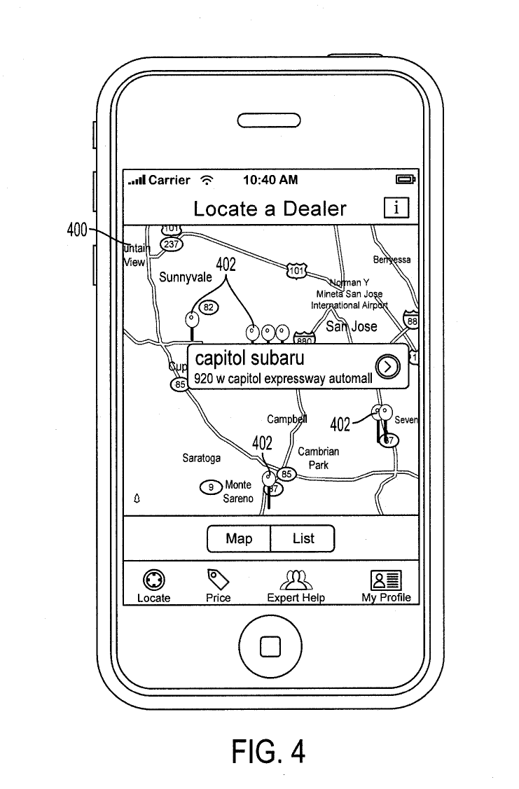

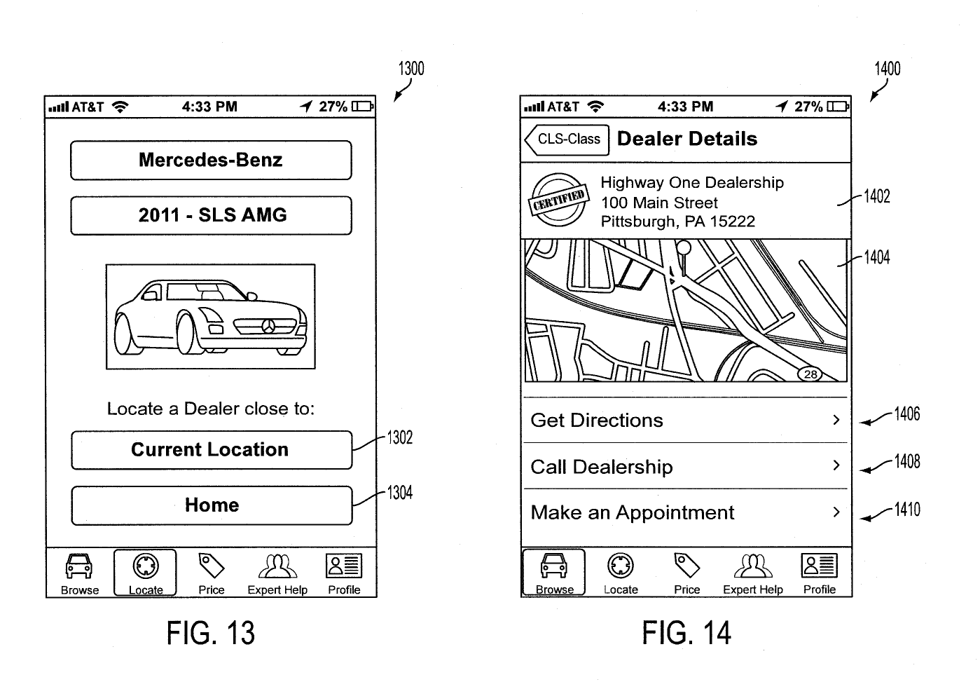

At a product dealer state 106, the service provider system 12 may provide the app/customer device 14 with a list of product dealers. The product dealers may be provided in the form of a list or a map. Dealers included in the list may be selected, for example, based on their proximity to the current and/or home location of the customer. FIG. 3 is a representation showing one embodiment of a dealer locator screen 300 of the app. As illustrated in FIG. 3, dealers may be provided in a list. In some embodiments, as shown, a distance from the customer's current or home location to each dealer may be listed under the dealer. FIG. 4 is a representation showing one embodiment of a dealer locator map screen in the app. In the screen of FIG. 4, dealers are presented as markers 402 on a map, showing the relative locations of the dealers. Dealers may be provided to the customer in response to a generally query (e.g., all participating dealers near the customer's home or current location). In some embodiments, dealers may be provided in response to a request for a particular product. For example, FIG. 13 is a representation showing one embodiment of a user interface screen 1300 that may be shown through the app to provide a dealer location feature based on a requested product. As shown in the screen 1300, the customer has specified a product of interest, (i.e., a 2011 SLS AMG). Selecting button 1302 may cause the app/customer device 14 to display a list of dealers near the current location of the customer device 14 that stock the product of interest, while selecting button 1304 may cause the app/customer device 14 to display a list of dealers near the customer's home location that stock the product of interest.

At a dealer detail state 108, the service provider system 12 may provide dealer detail information to the customer, via the app/customer device 14. The dealer detail information may include, for example, an address of the dealer and other dealer information. In some embodiments, the dealer detail information may include information about the dealer's stock (e.g., whether the dealer has a particular model or trim level in stock). FIG. 14 is a representation showing one embodiment of a user interface screen 1400 providing detailed dealer information (e.g., through the app). A general field 1402 includes general information about the dealer including, for example, the dealer's name and address. A map field 1404 may show a map of the generally vicinity of the dealer. The screen 1400 may also provide prompts allowing the customer to request additional information about and/or interact with the dealer. For example, a button 1406 may allow the customer to request directions to the dealer (e.g., from the customer's home and/or current location). A call button 1408 may allow the customer to initiate a telephone call with the dealer (e.g., using the customer device 14). In some embodiments, selecting the call button 1408 may display a telephone number of the dealer, allowing the customer to call the dealer with another device. An appointment button 1410 may allow the customer to make an appointment to visit the dealer. For example, selecting the button 1410 may allow the customer to interact with a scheduling feature of the dealer system 20 corresponding to the selected dealer and/or speak directly with a dealer representative.

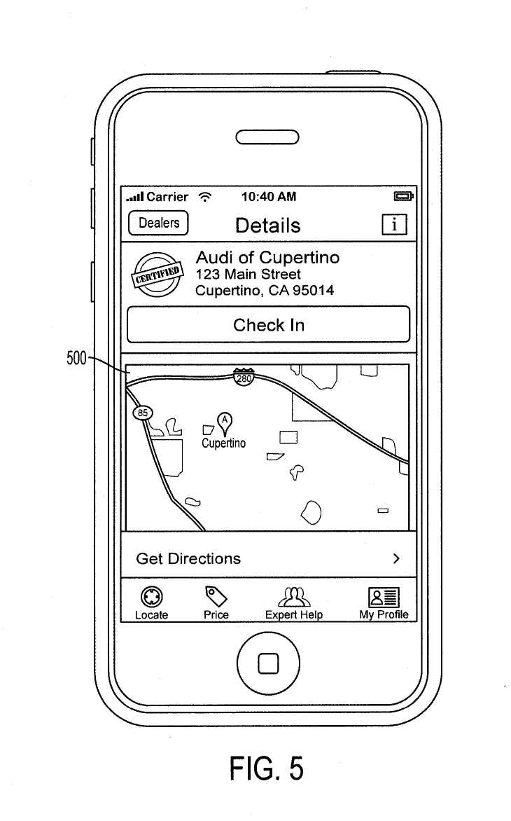

Independent of receiving the dealer information, the customer may physically travel to a selected dealer. At the dealer, the customer may check-in at the dealer. FIG. 5 is a representation showing one embodiment of a dealer check-in screen 500 of the app. For example, while at a dealer, the customer may select from the app an option to check in. The app/customer device 14 may provide a screen similar to that shown in FIG. 5, which includes an indication of the dealer at the current location. The customer may be provided with a “check-in” button as shown to check-in at the dealer. If more than one dealer is at or near the current location, the service provider system 12 may provide the customer device 14 with each of the possible dealers, allowing the customer to select the dealer where the customer is present. In various embodiments, the service provider system 12 may store the fact of the check-in in association with the dealer and, in some cases, the customer. For example, this may allow the service provider to demonstrate the number of customers that the service provider has actually delivered to the dealer's location. In some embodiments, check-in may be required before the customer may receive pricing information. For example, dealers may not want to publicize the pricing terms to which they have agreed except to customers actually at their location. Also, in some embodiments, the dealer, the manufacturer or both may offer rebates or incentives to customers who check-in at a dealer. When rebates are offered, they may be considered in calculating a rebated sales price, as described below. Other offers to customers for checking-in at a dealer may include, for example, test drive incentives, other give aways, etc.

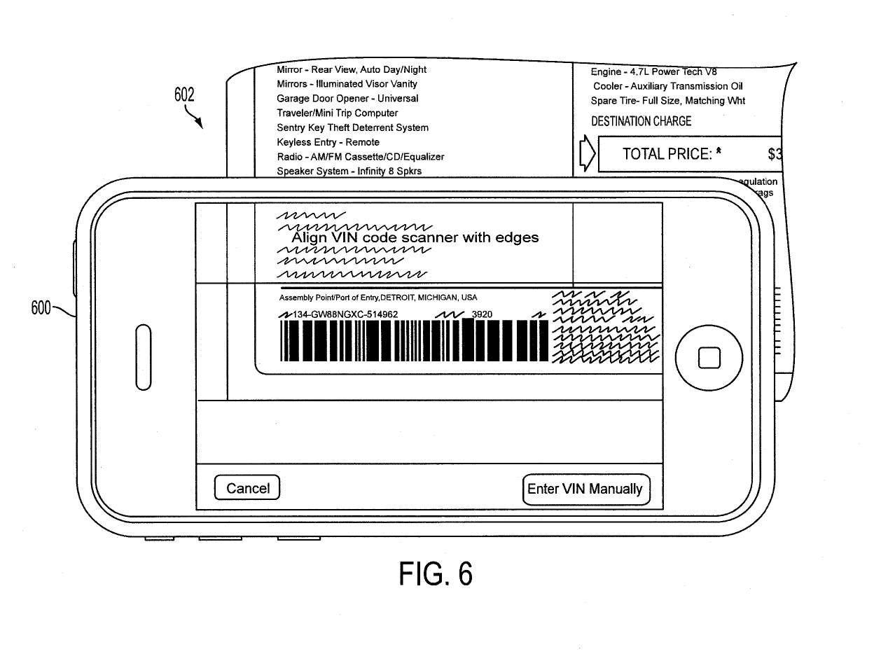

Upon check-in, the customer may proceed to a scan guide or scan state 114 for receiving an identifier of a product instance. In some embodiments, the application may pass through the home state 104 to reach the scan state 114. For example, the customer may prompt the app/customer device 14 to enter the scan state 114 from the home state. From the scan state 114, the app/customer device 14 may determine, at 116, whether the customer device 14 supports physical scanning of a product instance identifier (e.g., for cars, a VIN number). Physical scanning may be supported in a number of different ways. For example, the customer device 14 may have a camera for capturing a bar-code representing the identifier and/or an alphanumeric representation of the identifier. The app/customer device 14, or other suitable software, may decode the bar-code and/or perform optical character recognition on an alphanumeric representation. Any other scanning technology may be used including, for example, QR codes, radio frequency identification (RFID) technology, etc. In some embodiments, capturing the product identifier from an instance of the product may include scanning a bar code, QR code, VIN number, etc. physically on the product instance or associated with the product instance. If scanning is supported, the app/customer device 14 may allow the customer to scan a product instance identifier at 118. FIG. 6 is a representation showing one embodiment of a customer scanning a product instance identifier (here a VIN number), into the app/customer device 14. FIG. 6 shows a screen 600 showing a view of a camera of the consumer device 114, as well as a larger label 602 including the VIN number, represented as a bar code.

If the customer device 14 does not support scanning, the app/customer device 14 may proceed to a manual identifier entry state 120 from which the customer may manually enter the product instance identifier (e.g., using a keyboard or keyboard feature of the customer device 14). In some embodiments, a sales price may only be available after the product instance identifier is automatically scanned and not after a manual entry of the product instance identifier. In various embodiments, after receiving the product instance identifier, the app/customer device 14 may, at decision 122, determine whether the customer is checked-in at a dealer. If the customer is not checked-in at a dealer, the app/customer device 14 may enter a nearby dealer list state at 126. From this state 126, the app/customer device 14 may prompt the customer to select among dealers near the customer's current location (e.g., a current location of the customer device 14). In other embodiments, the app/customer device 14 may prompt the customer to confirm that the customer is at the dealer having an inventory including the product indicated by the product instance identifier. If the customer is checked-in to the proper dealer at 122, the app/customer device 14 may determine at 124 whether the customer is still at the location of the proper dealer. For example, the app/customer device 14 may find the current location of the customer device 14 and compare it to a location of the dealer (e.g., received from the service provider system 12). Provided that the customer is still at the location of his or her last dealer check-in, the app/customer device 14 may enter a certified lowest price or pricing information state at 128.

In the pricing information state 128, the app/customer device 14 may request pricing information for the identified product instance from the service provider system 12. The service provider system 12 may use the product instance identifier to access a dealer system 20 associated with the dealer stocking the product instance and obtain an invoice price for the product instance. The invoice price, for example, may be stored at a stock data store of the dealer system 20. In some embodiments, the offset may be stored off of the service provider system 12. For example, in some cases, dealer prices may be negotiated between dealers and a price setting party. Accordingly, the amount of the offset may be initially known to the price setting party and stored at a price setting party system 34. Accordingly, the service provider system may, in some cases, obtain the offset by providing the product instance identifier. The price setting party 34 may return the offset to the service provider system 12.

The service provider system 12 may apply an offset to the invoice price to generate a sales price. The offset for the product and dealer may be stored, for example, at a data store of the service provider system 12, or at the data source of the dealer system 20. Further, the service provider system 12 may apply customer rebates and/or incentives to the sales price to generate a rebated sales price, at state 130. Customer rebates may be offered, for example, by the dealer and/or by a manufacturer. Data describing manufacturer rebates and/or incentives may be received by the service provider system 12 from a manufacturer system 16 associated with a manufacturer of the product. Data describing dealer rebates or incentives, if any, may be received form the data store of the appropriate dealer system 20.

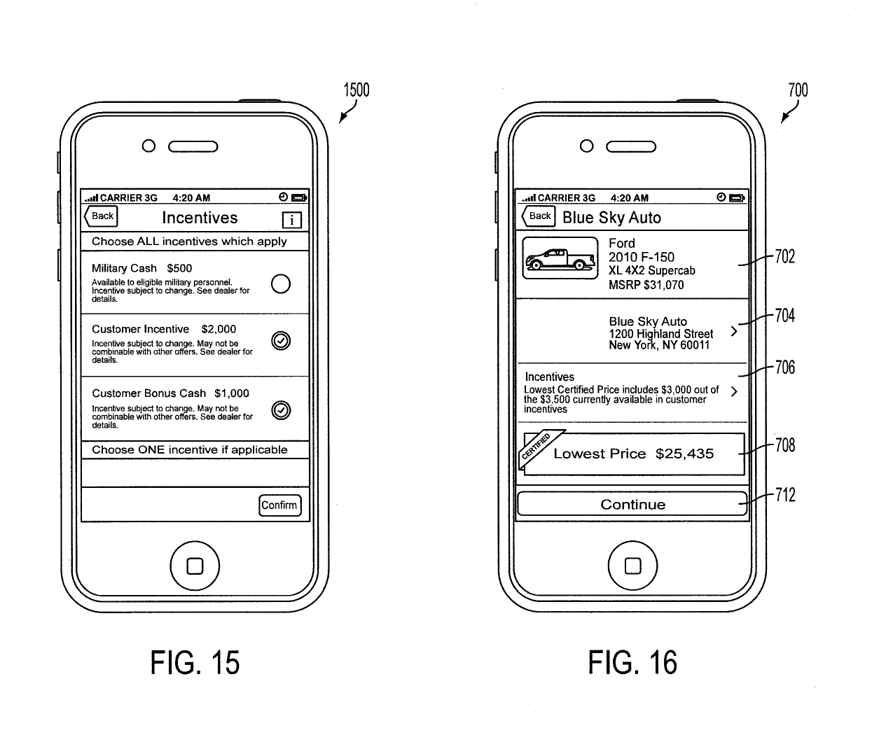

Some customer rebates may apply only to certain customers. Accordingly, the service provider system 12 may apply customer information to determine which rebates and/or incentives apply. Customer eligibility for some rebates and/or incentives may be determined based on user profile information. Optionally, the service provider system 12 may determine the customer's eligibility for such rebates and/or incentives automatically. For other rebates and/or incentives, it may be necessary to prompt the customer for additional information (e.g., via the app/customer device 14). The additional information may be requested in raw form. For example, if the applicability of a certain incentive depends on whether the customer is a military veteran, the customer may be prompted, through the app, to indicate whether he or she is a military veteran. Also, in some cases, instead of requesting specific information, the service provider system 12 may cause the app/customer device 14 to list potentially applicable rebates and/or incentives and prompt the customer to indicate which ones for which he or she is eligible. For example, FIG. 15 is a representation showing one embodiment of a user interface screen 1500 providing such an incentive/rebate selection feature to the customer via the app. The screen 1500 may list potentially available rebates and/or incentives. The customer may select the rebates and/or incentives that apply.

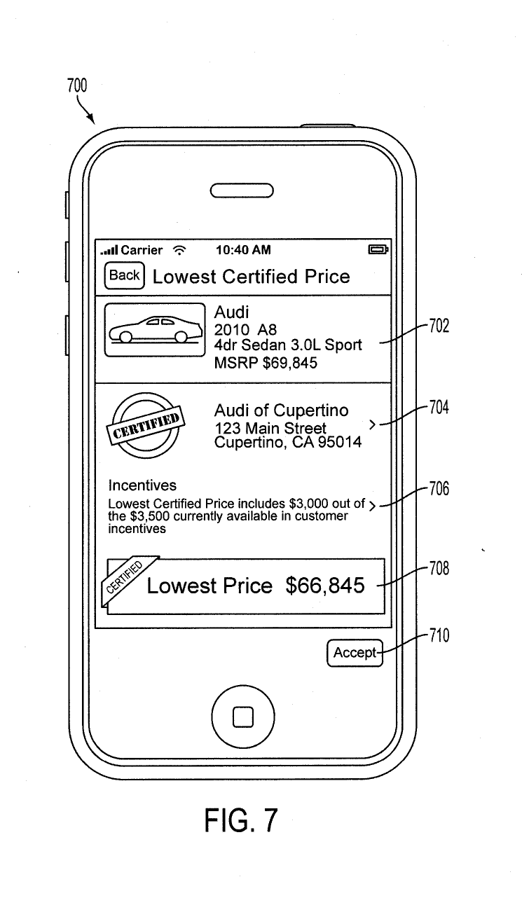

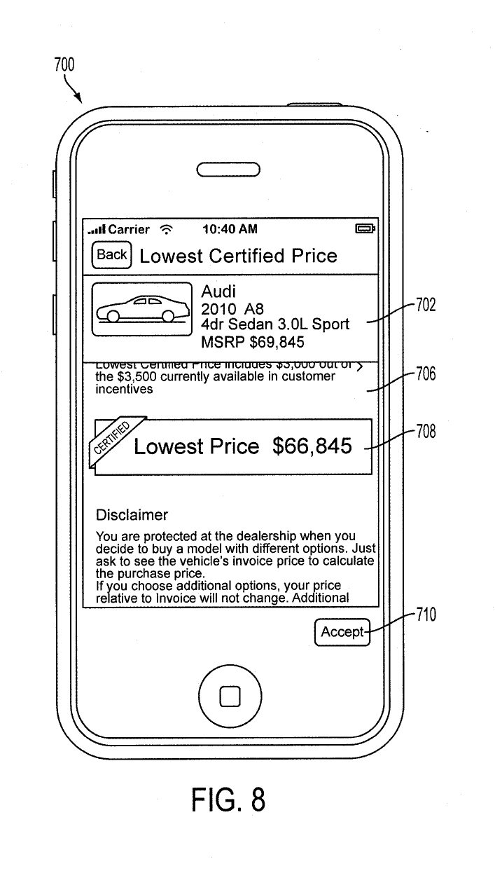

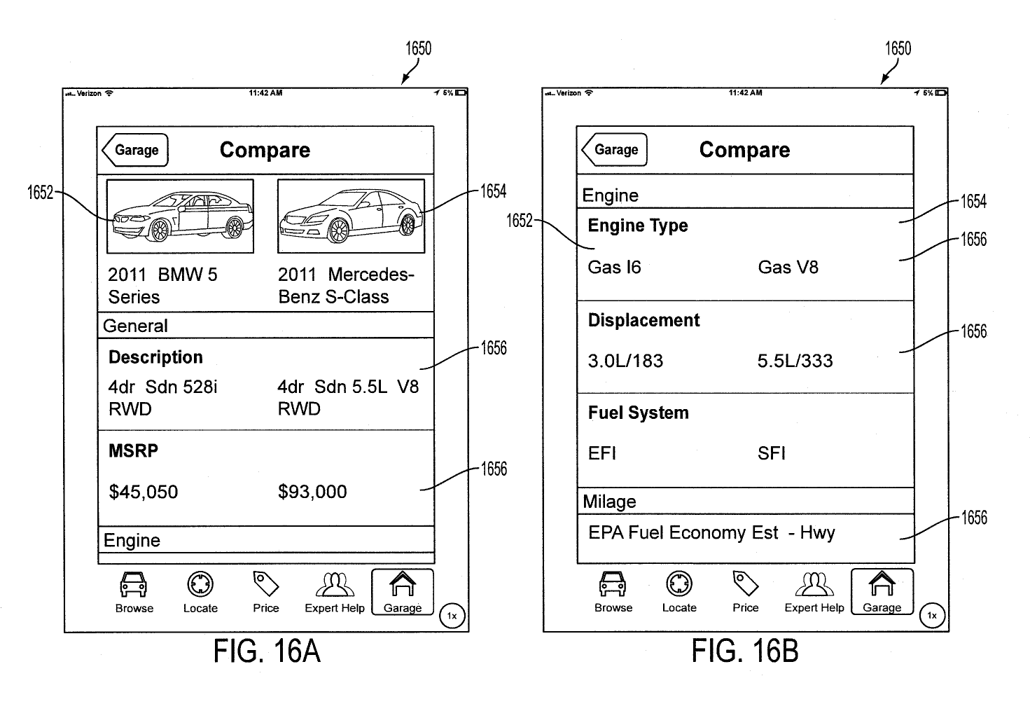

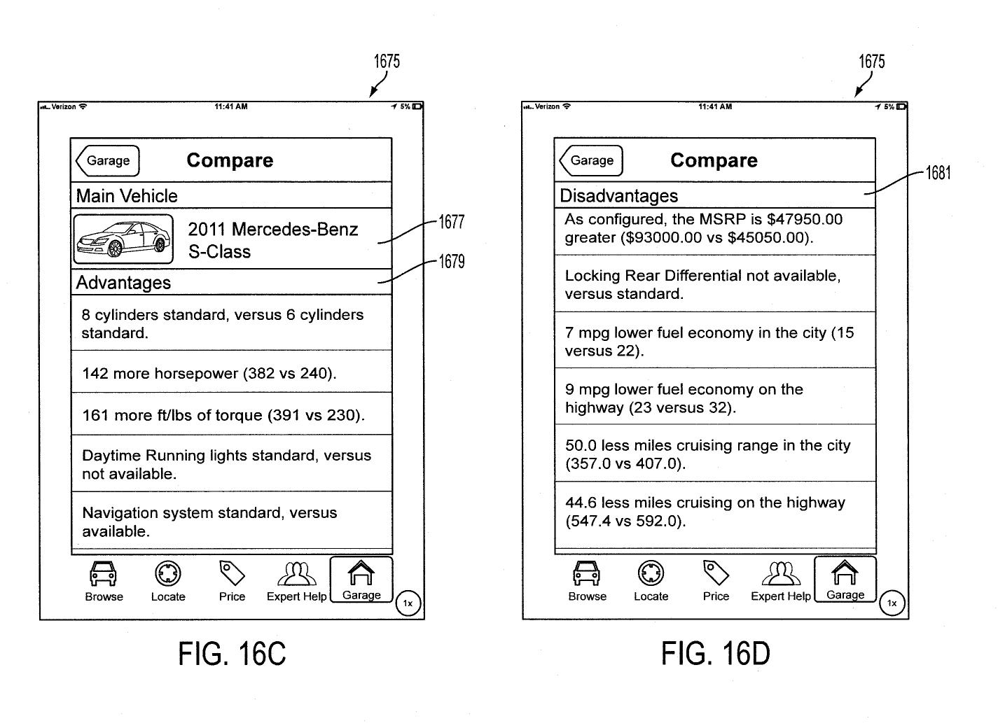

Upon receiving and/or determining the applicable rebates and/or incentives, the service provider system 12 may determine a rebated sales price. The rebated sales price may represent the actual price that the customer will pay for the product instance at the selected dealer. It may be provided to the app/customer device 14 and displayed to the customer. For example, FIGS. 7 and 8 are representations showing one embodiment of a car pricing screen 700 in the car pricing application of FIG. 2 displaying a rebated sales price. The screen 700 may indicate the product, including MSRP, at 702. At field 704, the screen 700 may indicate the dealer. Incentives and/or rebates considered in finding the price may be listed at a filed 706. The rebated sales price itself may be listed at field 708. The customer may accept the rebated sales price by selecting button 710. Accepting the rebated sales price may indicate that the customer would like to purchase the product instance. For example, notice of a customer's acceptance may be relayed from the customer device 14 through the service provider system 12 to the appropriate dealer system 20. The dealer system 20 may then, in some cases, mark the product instance as reserved. FIG. 16 shows another embodiment of the car pricing screen 700 of FIG. 7 configured for a different product instance (here, a FORD F-150 vehicle). In lieu of an accept button, the interface 700, as shown in FIG. 16, comprises a Continue button 712. The customer may select the Continue button 712 either to accept the purchase of the product instance or, for example, to receive additional information about purchasing the product instance (e.g., financing information, etc.). In some embodiments, the service provider system 12 and/or app/consumer device 14 may be configured to provide the customer with information about an alternative product in the event that the customer does not accept the purchase of the product instance. For example, the presented alternative may have a lower price, monthly payment, etc.

Although the calculation of the pricing information is described above as being performed by the service provider, in various embodiments, some or all of the processing may be performed locally at the customer device 14. For example, the app/customer device 14 may comprise functionality for finding the pricing information. Information necessary for calculating the pricing information may be provided to the customer device 14, for example, through the service provider system 12. Also, in some instances, it may be desirable not to receive the invoice price from a dealer. For example, when the product is a new car, the invoice price is set by the manufacturer and is constant across all dealers. When the product is a used car, however, different dealers may pay different prices for different cars and cars in different conditions have different values. Accordingly, in such case, a third party pricing system 18 may be used such as, for example, KELLEY BLUE BOOK, NADA USED CAR GUIDE, BLACK BOOK, etc. The service provider system 12, instead of receiving the invoice value directly from a dealer system 20, may receive from the dealer system an indication of a condition of the product instance. Based on this information; the service provider system 12 may retrieve an invoice value of the product instance from a third party pricing system 18 (e.g., from a data store thereof). For example, the dealer system 20 may indicate that a particular used car is in fair condition. The service provider system 12 may access one or more third party pricing systems 18 to request a price for a product in fair condition having the features of the product instance. The value price received from the third party pricing system 18 may be the invoice price. In some embodiments, prices may be requested in this manner from more than one third party pricing system 18 and averaged to generate the invoice price.

In addition to the product price service described herein, the app/customer device 14 may be configured to provide the customer with product information. For example, the customer may request product information through the app/customer device 14. The app/customer device 14 may forward customer requests for information to the service provider system 12, where the request may be handed under the direction of the information module 30. The service provider system 12 may retrieve the requested information, for example, from a data store of the system and/or from other systems such as, for example, manufacturer systems 16 or other third party systems (not shown).

Product information provided to the customer in this way may allow the customer to research different products before traveling to a dealer and receiving pricing information for a product instance. Product information may be retrieved directly by the app/customer device 14 (e.g., from a manufacturer system 16 or other system). In other embodiments, product information may be received by the app/customer device 14 through the service provider. FIG. 10 is a representation showing one embodiment of a user interface screen 1000 providing information about a product. The screen 1000 may be provided to the app/customer device 14 by the information module 30 of the service provider system 12. The subject product shown in FIG. 10 is a MERCEDES-BENZ 2001 E-CLASS car, although systems and methods described herein may be utilized with any kind of subject product. A Summary menu item 1002, when selected by the customer, may cause the app/customer device 14 to display a screen summarizing information about the subject product. A Description menu item 1004, when selected by the customer, may cause the app/customer device 14 to display a screen including a more detailed description of the subject product. A Standard Features menu item 1006, when selected by the customer, may cause the app/customer device 14 to display a screen including standard features of the subject product. A Warranty menu item 1008, when selected by the customer, may cause the app/customer device 14 to display a screen including information about a warranty offered on the product (e.g., by the dealer or by the manufacturer). A Compare to Current Vehicle menu item 1010 may cause the app/customer device 14 to display a screen showing various properties of the subject product in conjunction with equivalent properties of another similar product (e.g., another model of car). The menu items 1002, 1004, 1006, and 1008 are based on common properties of car. When the environment 10 is used to provide information about products other than cars, different menu items may be used.

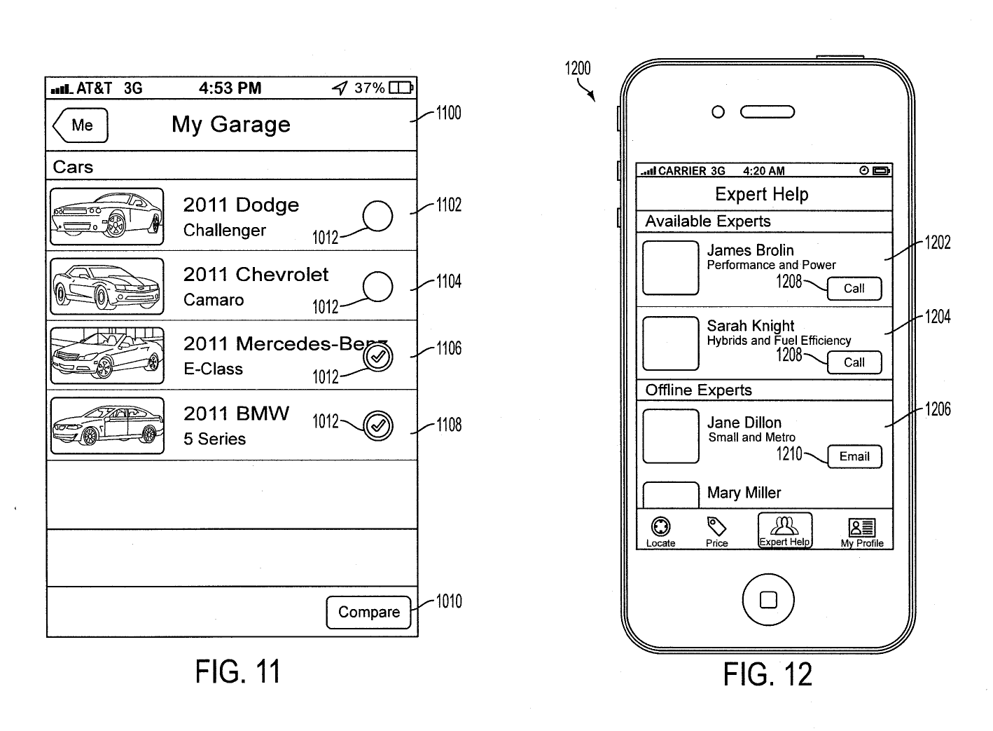

FIG. 11 is a representation showing one embodiment of a user interface screen 1100 providing information about multiple types of products at product fields 1102, 1104, 1106, 1108. For example, the product fields 1102, 1104, 1106, and 1108 may be populated with products for which the customer has previously requested information. The customer may select two or more of the products of the fields 1102, 1104, 1106, 1108 (e.g., by activating a selection button 1012). Selected products may be compared by activating the Compare button 1010. The comparison may be presented on another screen or screens comparing various properties of each selected product.

FIGS. 16A and 16B are representations showing one embodiment of a user interface screen 1650 for comparing properties of selected products. The screen 1650 may comprise a column corresponding to each product to be compared. As illustrated in FIGS. 16A and 16B, two products are being compared, so the screen 1650 has a first column 1652 (corresponding to a 2011 BMW 5 SERIES) and a second column 1654 (corresponding to a 2011 MERCEDES-BENZ S-CLASS). The screen 1650 may also comprise one or more rows 1656, with each row corresponding to a property of the products. Each product's value for the property may be displayed at the corresponding column 1652, 1654 and row 1656, as shown. FIGS. 16C and 16D are representations showing one embodiment of another user interface 1675 for comparing properties of selected products. The screen 1675 displays comparison information in terms of a main product and shows differences in a secondary product relative to the main product. For example, in FIGS. 16D and 16D, the main product, shown in main product window 1677, is a 2011 MERCEDES-BENZ S-CLASS while the secondary product is a 2011 BMW 5 SERIES. Advantages field 1679 lists features of the main product that are superior to corresponding features of the secondary product. Similarly, disadvantages field 1681 lists features of the main product that are inferior to corresponding features of the secondary product.

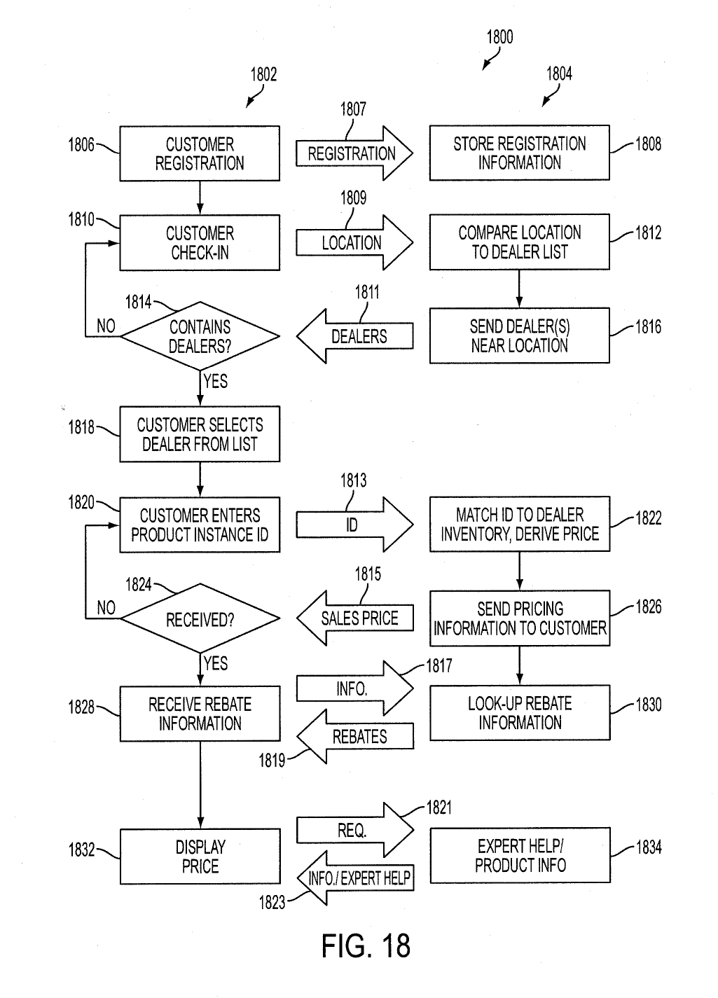

FIG. 18 is a diagram showing one embodiment of a process flow 1800 for facilitating product purchases. The process flow 1800 comprises actions in two columns. Actions in column 1802 are performed by the app/customer device 14, while actions in column 1804 are performed by the service provider system 12. The process flow 1800 represents just one division of actions between the customer device 14 and service provider system 12. It will be appreciated that any suitable division may be used. At 1806, the customer may register the app. Registration, as described above, may involve the customer downloading the app from the service provider system 12 or another system and providing the service provider system 12 with registration information 1807 including, for example, a user name, e-mail address, home location, etc., as described above. Registration information 1807 may be stored by the service provider system 12 at 1808, for example, at a data storage unit thereof. FIG. 2, described above, illustrates an example interface screen that may be shown to the customer by the app/customer device 14 to prompt the entry of registration information.

At 1810, the customer may check-in to a dealer, for example, similar to the description above. It will be appreciated that between registering at 1806 and checking in at a dealer in 1810, the customer may request and receive information on various different kinds of products, for example, as described herein above with respect to FIGS. 10 and 11. In this way, the customer may decide which vehicle or vehicles are of high enough interest to the customer to justify receiving pricing information. FIG. 5, described above, shows a screen 500 that may be provided to the customer to check-in to a dealer. Upon check-in, the app/customer device 14 may take a current location 1809 of the customer device 14, which may be transmitted to the service provider system 1212. At 1812, the service provider system 12 may compare the customer location to the known locations of dealers. A list 1811 of one or more dealers at or near the customer location may be provided to the app/customer device 14 at 1816. At 1814, the app/customer device 14 may prompt the customer to verify that the list 1811 includes the dealer where the customer is present. For example, the list 1811 may not include the dealer if the customer is not actually at a dealer, or the customer is at a dealer that does not participate in the pricing information service. Provided that the list 1811 includes the dealer, the customer may select the proper dealer from the list or a graphical representation thereof at 1818. The screen 300 of FIG. 3, described above, includes a list of potential dealers, while the screen 400 of FIG. 4, also described above, includes a map of potential dealers.

At 1820, the customer may enter into the app/customer device 14 a product instance identifier 1813 (e.g., VIN number for cars). The identifier 1813 may be entered utilizing a camera or other scanning hardware of the customer device 14, for example, as described above and illustrated by the screen 600 of FIG. 6. In some embodiments, the customer may manually enter the identifier 1813, for example, utilizing a keyboard or similar function of the customer device 14. Also, in some embodiments, it may not be necessary for the customer to be physically present with the product instance. For example, the customer may receive the identifier, or an indication thereof, from a web site (e.g., a website of the dealer). The identifier may then be entered manually into the app/customer device 14. The app/customer device 14 may transmit the identifier 1813 to the service provider system 12. When the service provider system 12 receives the identifier 1813, it may match the identifier 1813 to an inventory of the appropriate dealer and derive the price information for the product instance at 1822. For example, as described above, the service provider system 12 may retrieve an invoice price for the product instance from the appropriate dealer system 20. The sales price may be derived, as described herein, by applying an offset to the invoice price. Optionally, the sales price may be transmitted to the app/customer device 14, which may receive the same at 1824. If the sales price (or other pricing information) is not received, the app/customer device 14 may return to 1820.

The service provider system 12 may look-up customer rebate and/or incentive information 1819 at 1830 and provide the same to the app/customer device 14, which may receive the information 1819 at 1828. The information 1819 may indicate customer rebates and/or incentives that the customer is, or may be, eligible for. In some embodiments, the customer may provide additional rebate related information 1817. Such information may include information describing the customer and/or selections of specific customer rebates and/or incentives that may apply to the customer, as described above with respect to the screen 1500 of FIG. 15. Also, the applicability and/or amount of some incentives or rebates may depend on previous customer interactions with the service provider system 12. For example, the service provider system 12 may provide the appropriate manufacturer system 16 with information describing product information requests and/or previous quote or pricing information requests from the customer. The manufacturer system 16 may utilize this information in determining the applicability and amount of available rebates and/or incentives. The service provider system 12 and/or the app/customer device 14 may calculate the rebated sales price, if any rebates apply. Pricing information may be displayed to the customer by the app/customer device 14 at 1832. The pricing information may include the sales price and/or the rebated sales price, if applicable. For example, screen 700 shown in FIGS. 7, 8 and 16, described above, illustrate the provision of pricing information to the customer.

Additional product information and/or expert help 1823 may be provided to the app/customer device 14 upon request by the service provider system 12 at 1834. Screens 1000 and 1100 of FIGS. 10 and 11, described above, illustrate the provision of product information in response to a customer query. Also, for example, screen 1200 of FIG. 12, described above, illustrates the provision of expert help to a customer. Although the requests for product information and/or expert help 1823 are illustrated at the end of the process flow 1800, it will appreciated that information and/or expert help 1823 may be requested by and provided to the customer at any point in the process flow 1800 including, for example, between registration and check-in at a dealer.

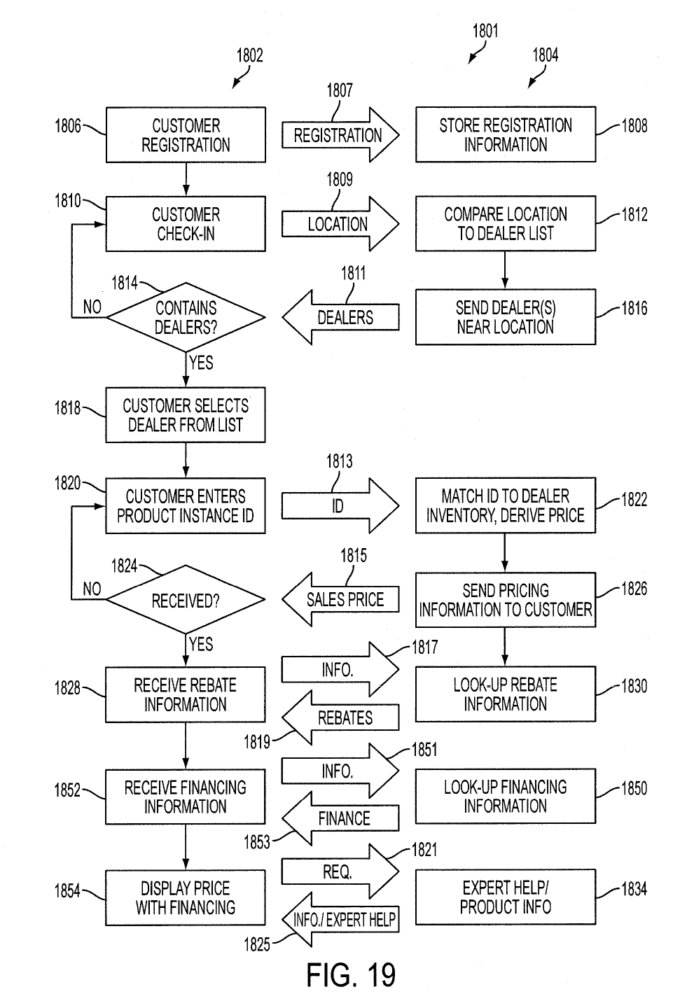

FIG. 19 illustrates another embodiment of the process flow 1800 including finance support. The service provider system 12 may contact one or more finance entity systems 22 to receive financing quotes for the customer's purchase of the product instance, (e.g., after determining pricing information for the product instance). For example, the service provider system 12 may receive financing information 1851 from the customer and look up financing information 1850. The financing information 1851 may include any information that may be necessary or desirable to determine financing terms for the customer including, for example, credit information, an institution preference, a credit report authorization, a trade-in value, a down payment amount, etc. In some embodiments, information regarding the customer's trade-in may be received during the registration process and/or before the customer requests pricing information on a particular product instance. The app/customer device 14 and/or service provider system 12 may calculate a value for the trade-in, for example, based on pricing information received from one or more third party pricing systems 18. Also, in some cases the app may comprise one or more screens (not shown) for receiving data regarding a customer's trade-in.

The financing information 1851 may be provided to the finance entity systems 22 via the service provider system 12. Based on the financing information 1851, the service provider system 12 may receive financing terms 1853 for the customer from the finance entity system 22. The financing terms may include, for example, a monthly payment, an interest rate, etc. The financing terms 1853 may be provided to the app/customer device 14 at 1852 and displayed to the customer. In some embodiments, the service provider system 12 may query and receive financing terms from multiple finance systems 22 representing multiple financial institutions. The service provider system 12 may forward all received financing terms to the app/customer device 14 or, in some embodiments, may select the most favorable terms for provision to the app/customer device 14, for example, based on the lowest monthly payment.

In various embodiments, the apps/customer devices 14 and/or the service provider system 12 may allow customers to record events during the product purchase process to social media and/or publishing outlets, such as, for example, FACEBOOK, TWITTER, MYSPACE, etc. At certain points in the purchase process, the app/customer device 14 and/or the service provider system 12 may query the customer to post an indication of the purchase process to one or more social media sites. For example, the customer may be prompted to post upon check-in at a dealer, upon entering a product instance identifier, upon purchasing a vehicle, etc. In some embodiments, the app/customer device 14 and/or service provider system 12 may compose the post, which may include, for example, textual descriptions of the customer's purchase state (e.g., “Joe Smith is shopping for cars at North Shore Chevrolet”) as well as photographs of any products that the customer is considering or has purchased.

Referring back to FIG. 17, in various embodiments, the environment 10 may be used to implement a dealer interface for facilitating communication between product dealers and potential customers. For example, the service provider system 12 may host the interface under the direction of the interface module 28. Dealers and representatives of dealers (dealer users) may access the interface using dealer devices 32 communicating on the network 24. The interface, as described herein, may provide dealers with opportunities to interact with customers based on the customers' search and pricing activity. In some embodiments, dealer interaction with customers may include text messages, images of products, coupons or other product purchase incentives, etc. In some embodiments, the interface may be rendered differently for dealer users from different dealers or associated groups of dealers. For example, dealer users associated with a dealer or group of dealers may be provided with information about and access to only a select group of customers relevant to the dealer or dealer group (e.g., customers who have requested information or pricing about products sold by the dealer or group, customers who are within a predetermined proximity to the group, customers who have specifically requested to be contacted by the dealer or group, etc.).

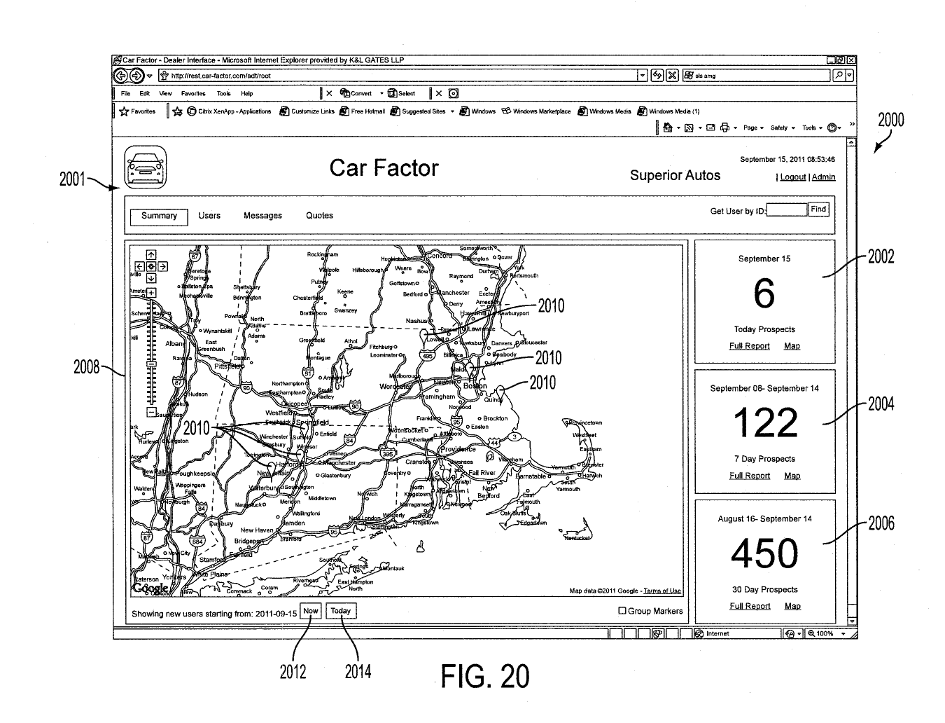

FIGS. 20-26 illustrate screen shots of various embodiments of the interface 2000. FIG. 20 is a screen shot showing one embodiment of a summary screen 2001 of the dealer interface. The summary screen 2001 shows report fields 2002, 2004, and 2006. The fields 2002, 2004, 2006 indicate a number of customers who have accessed services offered by the service provider 12 (e.g., price and information services described above) in the current day (2002), during the previous seven days (2004) and during the previous thirty days (2006). The screen 2000 also shows a customer field 2008 including indications of customers who have accessed or are accessing services offered by the service provider 12. The field 2008, as illustrated in FIG. 20, shows a map and places markers 2010 on the map to represent customer locations. In some embodiments, customers appearing on the field 2008 as markers 2010 may be customers who have a relationship to the dealer viewing the screen 2001. For example, the customers may have requested information or a price from the service provider system 12 on a vehicle stocked by the dealer, may have requested information from the dealer, may have

Dealer users may access additional information about and/or communicate with the customers corresponding to markers 2010, for example, by selecting the marker 2010 associated with a customer. Placing the markers 2010 on a map or other field indicating geographic location may allow dealer users to focus attention on customers based on the customer's geographic location. For example, a dealer user may focus communications and incentives on customers that are relatively close to the dealer. Also, it may be desirable for some dealers to offer incentives to customers farther from the dealer to entice the customers to travel to the dealer. Also, for example, a dealer may focus communications and/or incentives on customers whose current and/or home location is very close to a dealer's competitor. In various embodiments, the customer field 2008 may be configured to display markers 2010 including currently active customers (e.g., customers who have performed a function with the service system 12 involving the provision of a current or home location such as a price search, registration, etc.). The customer field 2008 may also display markers 2010 indicating customers who have been active over various time periods (e.g., the last day, the last seven days, the last thirty days, etc.). In some embodiments the customer field 2008 may be configured to toggle between live and non-live views. For example, a dealer user may select the Now button 2012 to cause the customer field 2008 to display customers who are currently active (or have been active within a predetermined amount of time such as 1 minute, 10 minutes, etc.). The Today button 2014 may cause the customer field 2008 to list instead all customers that have been active during the current day. Also, although the customer field 2008 is illustrated as a map, it will be appreciated that some embodiments may merely list active customers with or without location information.

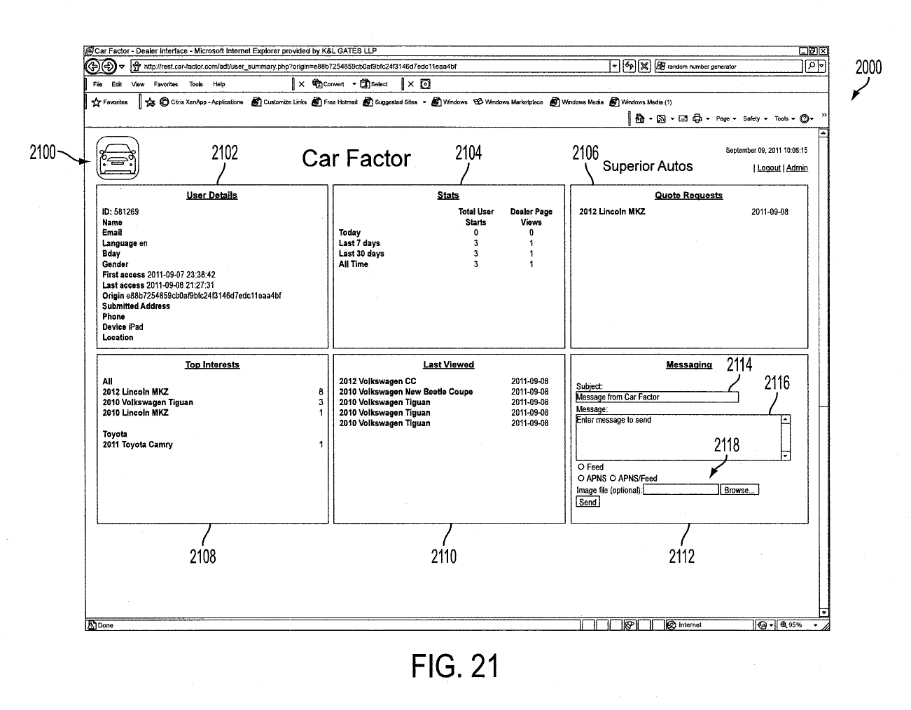

FIG. 21 is a screen shot showing one embodiment of a customer information screen 2100 of the dealer interface 2000. The screen 2100 may be displayed to a dealer user when the dealer user selects a marker 2010 corresponding to a customer from the screen 2001. As illustrated, the screen 2100 shows various information about the customer. A User Details field 2102 may provide information about the selected customer (customer information). In various embodiments, the customer information presented at the User Details field 2012 may be all or a portion of the customer registration information provided by the customer to the service provider system 12 as described above. In some embodiments, the dealer user may not be provided with an identity of the customer, as described herein below. For example, some customers may choose to remain anonymous. Accordingly, the User Details field 2102 may indicate an ID rather than a name or other information directly traceable to the customer. Other information at the User Details field 2102 may include the customer's language, gender, the date that the customer first and last accessed the service provider system 12, the type of customer device 14 used by the customer, etc. A Stats field 2104 may indicate additional information related to the customer's use of the service provider system 12. For example, the Stats field 2104 may indicate the number of times that the user has started the app over various time periods (e.g., today, last seven days, last thirty days, etc.). The Stats field 2104 may also indicate the number of times that the user has viewed a page or screen specific to a dealer associated with the dealer user. This could include, for example, checking-in at such a dealer, see screen 500 described above, as well as receiving information regarding a dealer, see screen 1400. A Quote Requests field 2106 may list quote or product instance pricing information that has been requested by the customer. A Top Interests field 2108 may provide the dealer user with information about the products for which the customer has viewed information, including the number of times that the customer has viewed information about each vehicle. Similarly, a Last Viewed field 2110 may list product types that the customer has most recently viewed including, for example, the date of last viewing. In various embodiments, the Top Interests field 2108 and Last Viewed field 2110 may be populated with information describing only products stocked by the dealer or dealers associated with the dealer user. A Messaging field 2112 may provide dealer users with functionality for contacting the customer detailed by the screen 2100. For example, the Messaging field 2112 may comprise a subject line 2114 and message field 2116 for receiving text. Images may be added utilizing image field 2118.

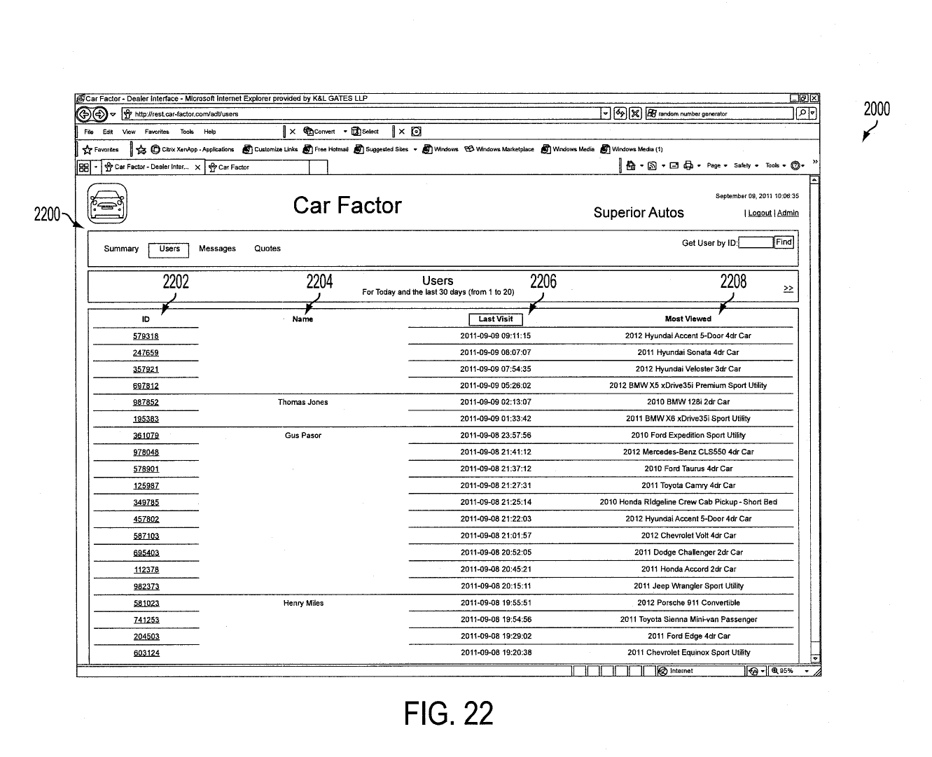

FIG. 22 is a screen shot showing one embodiment of a customer summary screen 2200 of the dealer interface 2000. The customer activity screen 2200 may list information describing customers that have recently interacted with the service provider system 12. An ID column 2202 shows an ID for each customer. A Name column 2204 shows a name for some or all of the customers (e.g., only for those customers who have chosen to provide their names to the dealer user). A Last Visit column 2206 shows the date and time of each customer's last interaction with the service provider system 12. A Most Viewed column 2208 shows, for each customer, the customer's most viewed product. The dealer user may, in some embodiments, access the customer information screen 2100 corresponding to a customer by selecting the customer from the list of screen 2200.

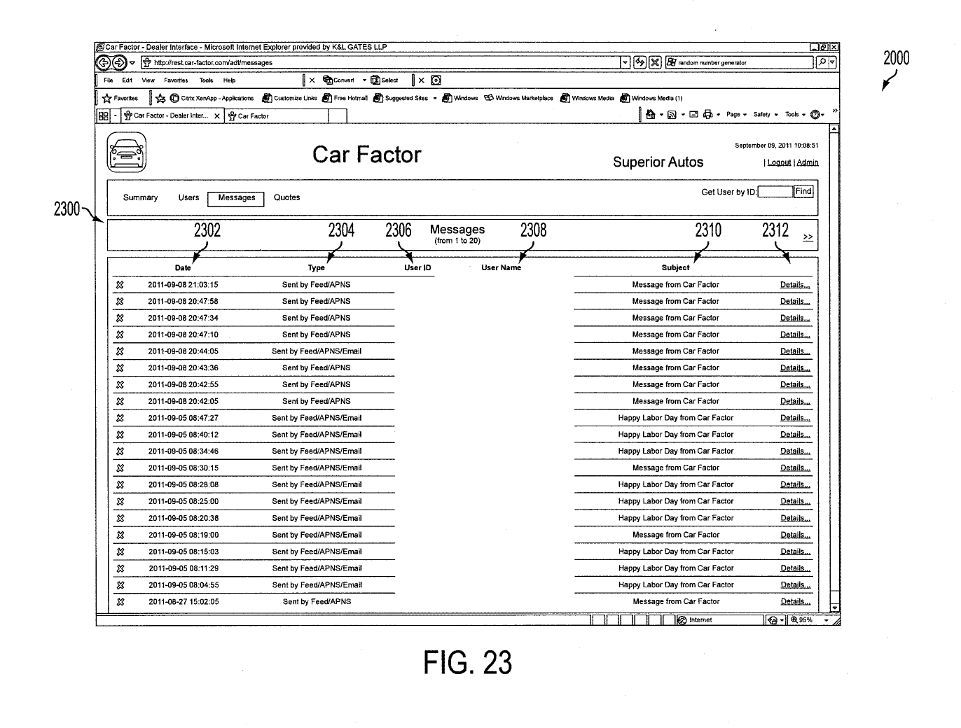

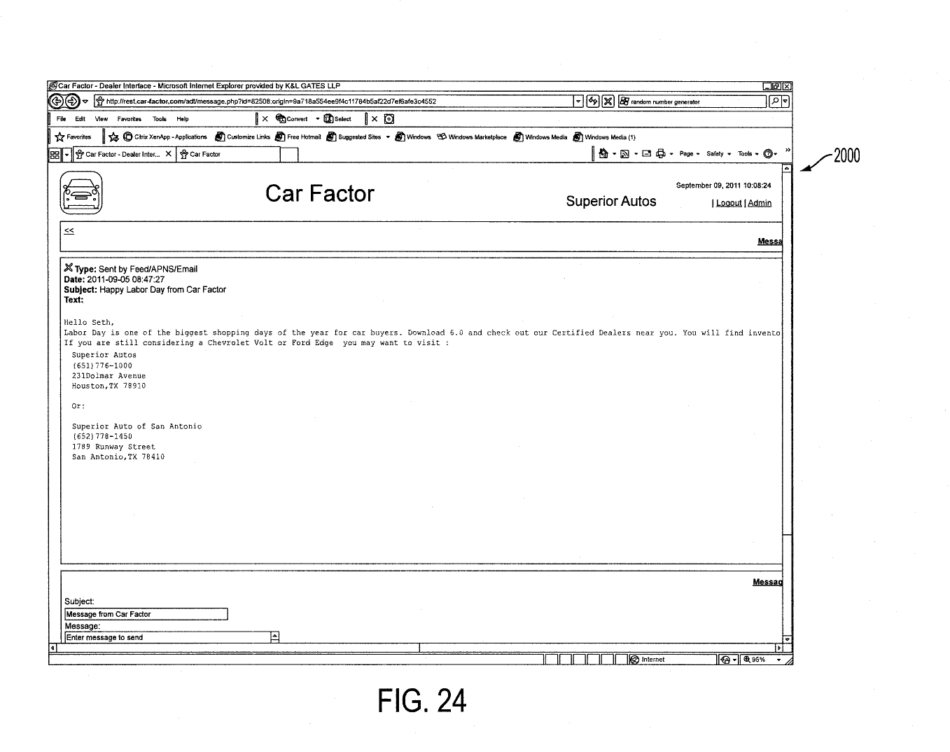

FIG. 23 is a screen shot showing one embodiment of a message screen 2300 of the dealer interface 2000. The message screen 2300 may list recent messages sent through the service provider system 12 including, for example, messages sent by dealer users or service provider users (e.g., users administering the service provider system 12). In some embodiments, the screen 2300 may list only messages sent by the dealer user or other dealer users associated with the same dealer or dealers. Date column 2302 may indicate a date of each message. Type column 2304 may indicate a type of each message (e.g., a sender for the message, a transport mechanism for the message, etc.). A User ID column 2306 may indicate an ID for the customer who was the recipient of each message. A User name column 2308 may indicate a name for the customers, if any, who decided to provide their identities to dealer users. The Subject column 2310 may list the subject of each message. A Details field 2312 may allow dealer users and service provider users to access additional details of each message. For example, FIG. 24 is a screen shot showing one embodiment of a message 2400 displayed through the dealer interface 2000. The message 2400 may be displayed upon selection of an entry in the details column 2312 of message screen 2300. The screen 2400 may show the content of a message sent to a customer, for example, utilizing the Messaging field 2112 described above.

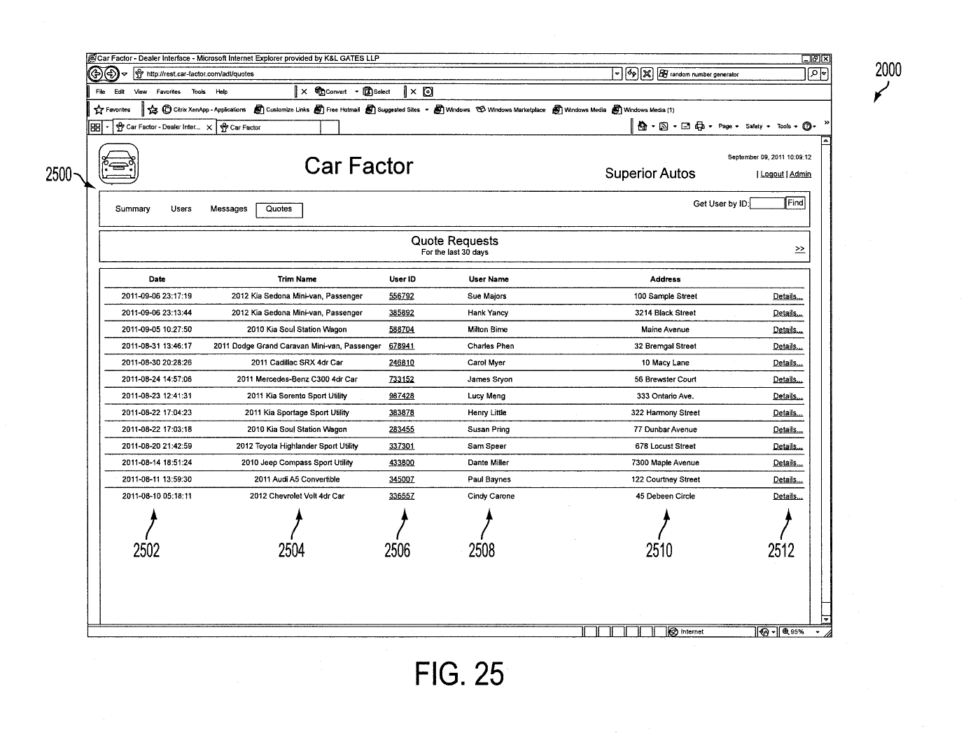

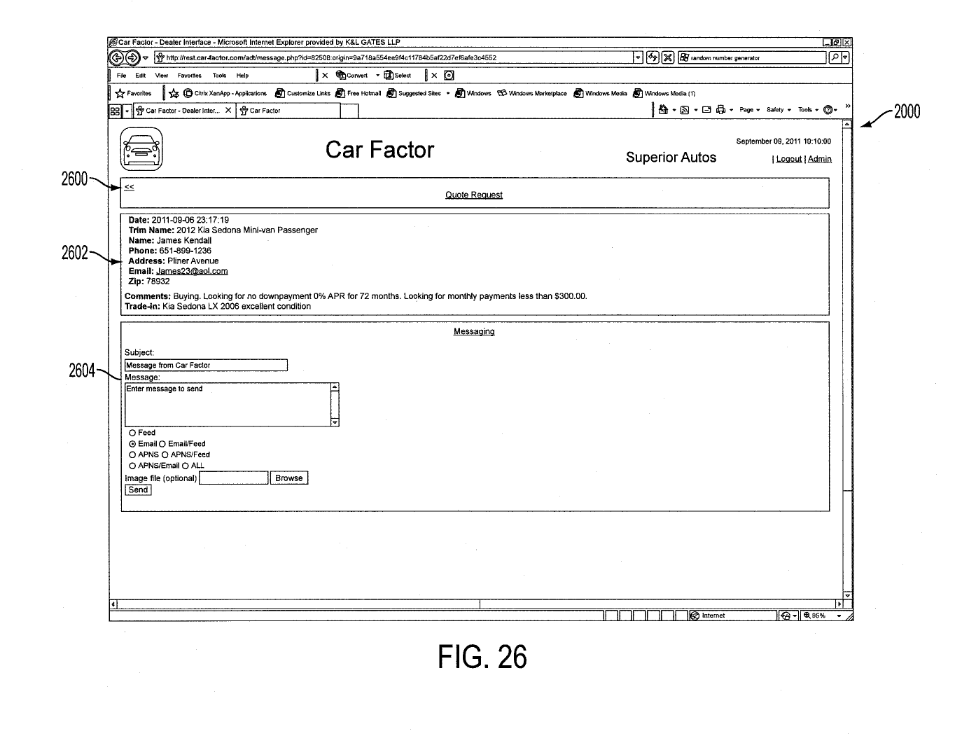

FIG. 25 is a screen shot showing one embodiment of a Quote Request screen 2500. The Quote Request screen 2500 may indicate recent product quotes or pricing information provided to customers by the service provider system 12. Pricing information may be provided, for example, as described herein above. Quote information, in some embodiments, may be provided to customers through the service provider system 12. In some embodiments, quote information may be provided directly from the dealer without the service provider system 12 or app/customer device 14 performing intermediate verification and/or processing. Accordingly, quote information may not be based on the offset from invoice method described above. The Quote Request screen 2500 may comprise a Date column 2502 indicating a date on which each request was made. A Trim Name column 2504 may identify the type of product for which the quote was requested. A User ID column 2506 may indicate an ID of the customer receiving the quote. Similar a User Name column 2508 may indicate the names of customers receiving quotes who have chosen to allow their identity to be shown to dealer users. An Address column 2510 may similarly list the addresses of customers receiving quotes who have chosen to allow their identity information to be provided to dealer users. A Details column 251 may allow dealer users to receive additional information about each quote request. For example, FIG. 26 is a screen shot showing one embodiment of a quote summary screen 2600 of the dealer interface 2000. The screen 2600 comprises a quote request field providing details of the customer's quote request. The dealer user may review the quote request and provide an answer, for example, by sending the customer a message using the Messaging field 2604.

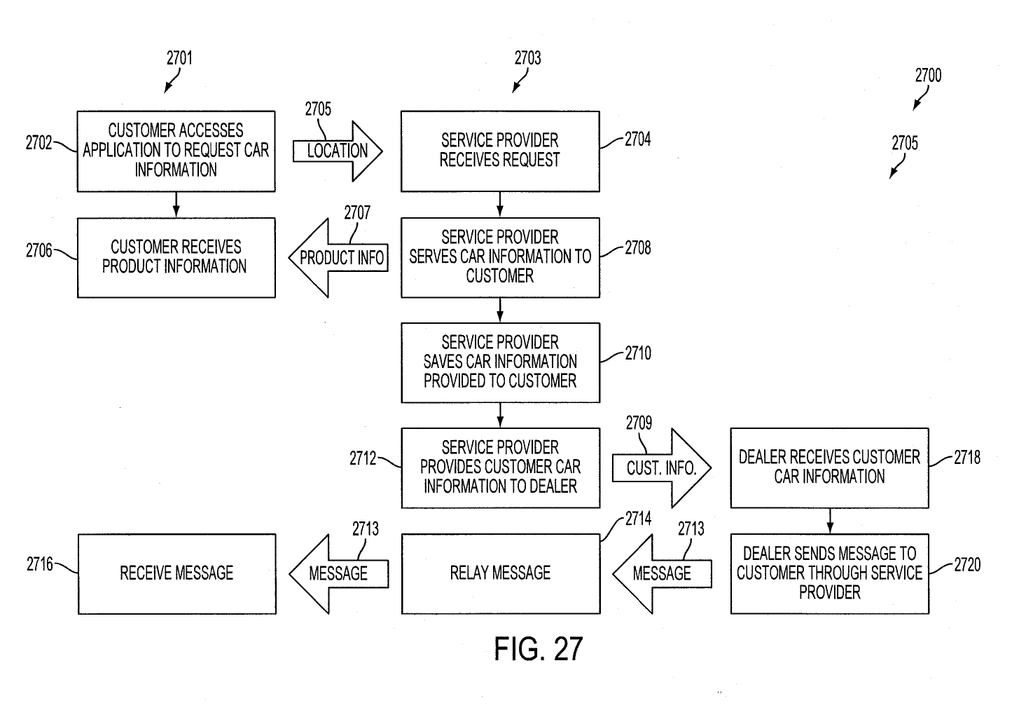

FIG. 27 is a diagram showing one embodiment of a process flow 2700 for facilitating communication between dealers and potential customers, for example, utilizing the dealer interface. The diagram comprises three columns 2701, 2703, 2705, with column 2701 including actions that may be performed by the customer or app/customer device 14, column 2703 including actions that may be performed by the service provider system 12 and column 2705 including actions that may be performed by a dealer user/dealer customer device 32. The process flow 2700 illustrates an example interaction between the customer and the service provider system 12, and between the service provider system 12 and the dealer user/dealer device 32. At 2702, a customer, through the customer's customer device 14, may access the app and request information about a product. In response to either activation of the app, the request for product information, or both, the app may cause the customer device 14 to capture its current location 2705 and provide the location 2705 to the service provider system 12. In some embodiments, the location 2705 may be a stored location, such as a customer home location, instead of a current location. The service provider system 12 may receive the request and location 2705 at 2704.

In response to the request, the service provider system 12 (e.g., directed, for example, by its information module 30) may provide product information 2027 to the app/consumer device 14, for example, as shown by screens 1000, 1100 and 1300 described above. The service provider system 12 may save the request and/or the provided information at 2710. At 2712, the service provider system 12 (e.g., directed, for example, by its interface module 28) may provide customer information 2709 to the dealer user/dealer device 32. The customer information 2709 may comprise product information previously provided to the customer, requests previously made by the customer, pricing information or quotes previously requested by the customer and, in some cases, customer identifying information.

The information 2709 may be provided unsolicited, or may be provided as a part of the dealer interface 2000 described herein. For example, the customer information 2709 may be displayed to the dealer user as part of the screens 2001, 2100 or 2200 described above. In some embodiments the information 2709 may not be provided to all dealer users. For example, the information 2709 may be provided only to dealer users associated with dealers having some connection to the product (e.g., the dealer stocks the product or a close competitor) or the customer (e.g., the dealer stocks another product that the customer has researched through the service provider system 12). Dealer users who are not to receive the information 2709 may not see any indication of the information when viewing the dealer interface 2000.

In various embodiments, the customer information 2709 provided by the service provider system 12 to the dealer user/dealer device 32 may not provide the dealer user with actual identity information describing the customer. Instead, the service provider system 12 may merely provide an ID describing the customer. The ID may be, for example, a hardware identifier of the customer device 14 such as, for example, a UDID or SIM number, which may have been received from the customer at registration. In some embodiments, to further protect the identity of the customer, the service provider system 12 may generate the ID provided to the dealer user by encrypting or otherwise hashing the hardware identifier.

In various embodiments, different customers utilizing the service provider system 12 may choose different levels of protection for their identities. For example, some customers may consent to having all identity information provided to dealer users. Others may prefer to only provide a hardware identifier. Some users may prefer that none of their information be provided to dealer users. Also, in some embodiments, users may choose particular dealers or dealer groups that may receive their information.

At 2718, the dealer user/dealer device 32 may receive the customer information 2709, for example, via the dealer interface 2000 described herein above. The dealer user may decide to send a message to the customer. At 2720, the dealer user/dealer device 32 may send a message 2713 to the customer. The message 2713 may not be delivered directly to the customer but, instead, may be relayed by the service provider system 12 at 2714. For example, when the dealer/dealer user is not provided with identity information for the customer, the message 2713 may merely use the ID of the customer. The service provider system 12 may use the ID to route the message to the appropriate customer/customer device 14 and/or translate the ID to an address for routing the message 2713 to the customer/customer device 14. The customer/customer device 14 may receive the message 2713 at 2716.

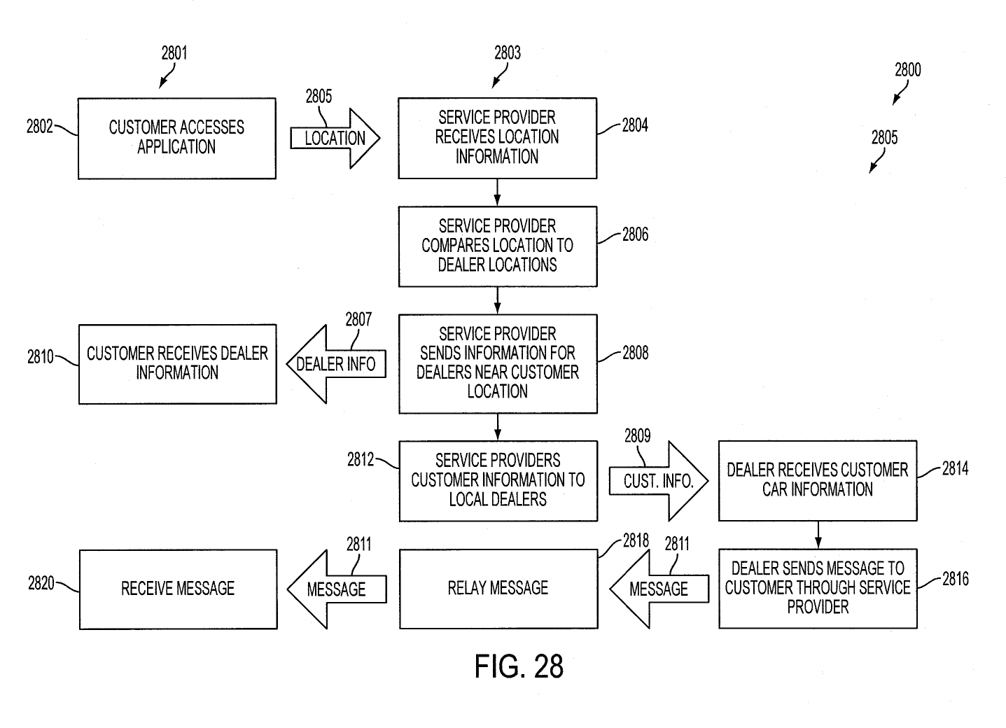

FIG. 28 is a diagram showing another embodiment of a process flow for facilitating communication between dealers and potential customers, for example, utilizing the dealer interface. Columns 2801, 2803 and 2805 correspond to actions that may be performed by the app/customer device 14, service provider system 12, and dealer user/dealer device 32, respectively, for example, similar to FIG. 27 above. At 2802, the customer may access the app, for example, by opening the app, registering the app (screen 200) signing-in to the app (screen 900), etc. Upon accessing the app, the app may cause the customer device 14 to capture a current location and/or provide a stored location (e.g., a customer home location) 2805 to the service provider system 12. The system 12 may receive the location 2805 at 2804. At 2806, the system 12 may compare the location 2806 to the locations of various dealers. At 2808, the system 12 may send the app/customer device 14 information 2807 for one or more dealers near the location 2805. The app/customer device 14 may receive the dealer information 2807 at 2810 and present it to the customer. The information 2807 may be presented to the customer in any form including, for example, the forms illustrated by screens 300, 400, 500, 1400, etc. At 2812, the service provider system 12 may provide customer information 2809 to one or more dealer users/dealer devices 32. Like the information 2709, the information 2809 may be provided to less than all dealer users/dealer devices 32 and may also be striped of customer identity information. For example, the information 2809 may be directed to one or more of the dealers for which information was provided to the app/customer device 14 at 2808.

At 2814, the dealer user/dealer device 32 may receive the information 2809. At 2816, the dealer user/dealer device 32 may send a message 2811 directed to the app/customer device 14. The message 2811 may be relayed by the service provider system 12 and received by the app/customer device 14 at 2820 in a manner similar to that described above with respect to FIG. 27.

In one aspect of the present invention, a system for providing a price to a consumer comprises a product identification code on an item selected by the consumer; a device for sending the product identification code to a database; and a device for displaying a price of the item to the consumer, wherein the item is an item that has a negotiable price.

In another aspect of the present invention, a method for purchasing a vehicle comprises selecting a vehicle of interest at a vehicle seller's location; sending identifying information about the vehicle of interest to a database; calculating a price of the vehicle of interest; sending the price of the vehicle of interest to a consumer.

These and other features, aspects and advantages of the present invention will become better understood with reference to the drawings, description and claims.

Broadly, an embodiment of the present invention provides an apparatus and methods for allowing a consumer to retrieve a vehicle's price through an automated process. The consumer may, through an application running on a mobile device, such as a smart phone (for example, an iPhone®, Android®, iPad®, Blackberry® or the like), take a picture of the vehicle's Manufacturers suggested retail price (MSRP) bar code, also known as a code 39 bar code. Alternatively, the consumer may manually enter the VIN into the application. The consumer may then receive, within a short period of often in less than 1 minute, a sales price for that specific vehicle. Additional pricing options may also be provided (such as dealer added accessories and the like) to the consumer as well. The price the consumer receives may be certified dealer's best price on the vehicle.

The application described above may also be available via, a web-based protocol. To use such a system, however, a user may be required to manually enter and/or photograph the bar code to retrieve pricing information. In alternate 20 embodiments, a consumer may use some other unique identification code to identify the vehicle instead of the VIN.

While the description provided herein discusses methods and systems for car pricing/car buying, the ideas, methods, and systems of the present invention may be applied to any retail environment where negotiating pricing is involved.

The steps below describe one aspect of the present invention.

Step 1—Download. Customer downloads a car pricing application (called, for example, CAR PRICE HERO, GROUPCAR, etc.) on their smart device (e.g., mobile device). Alternatively, the customer connects through another media, such as the web, wireless, 3G or 4G.

Step 2—Locate a Dealer. The customer searches the application to find one of the participating dealers.

Step 3—Choose Dealer. The application may use any suitable technology including, for example, Geo Mapping to locate the customer and query a database of dealers, find the nearest dealers and transmit the results on a map display to the customer.

Step 4—Travel to Dealer. The customer goes to the dealer to find an exact vehicle of interest. The customer may be at the dealer during regular business hours or even at off hours, so long as the consumer may have access to view the vehicles and obtain the VIN from the vehicles.

Step 5—Select Vehicle. The customer selects the vehicle of their choice, new or used.

Step 6—Locate Customer's Geo Location. The customer's location is pinged by their device using Geo Mapping to show the dealer they are visiting.

Step 7—Scan, Picture or Manual VIN Transmission. The customer takes a picture of the vehicle barcode or manually enters the VIN on a non camera device and submits this information using any device, such as a Palm®, I-Phone®, I-Pad', I-Pod®, Blackberry®, Android®, or any other mobile enabled operating system.

Step 8—Submission. The submission is sent via wireless, email or any other transmission to a host server.

Step 9—Read and Decode. Custom software may read the submission and decode the VIN and the dealer's location.

Step 10—Query Results. The results are queried against a database containing vehicle data. A match is found.

Step 11—Results are Formulated. The results are run through a pricing module. The pricing module may produce the dealer's best certified price and also describe all or any available factory rebates or incentives. The “best certified price” may be one that the dealer agrees as the lowest sales price for that particular vehicle. The pricing module may consider such items such as cost of the vehicle, vehicle, dealer markup, rebates, and the like.

Step 12—Transmission back to Customer. The host server sends the results through wireless, WI-FI, Internet, 3G, 4G, or any other transmission method, to the customer's smart device.

Step 13—Price Presentation. The dealer's best certified price is presented to the customer, typically within seconds, while the customer is at the side of the vehicle they choose

Step 14—Rebates and Incentives. The customer has the opportunity to view and select all available manufacturer's rebates and incentives.

Step 15—Customer Decision. The customer accepts the offer or continues to shop. In some embodiments, the pricing information of the vehicle may be stored on the customer's smart device for a limited period of time, such as several hours, to allow the customer to shop and compare various vehicles.

Step 16—Customer Actions. The customer goes into the dealer and finishes all paperwork needed to take their new vehicle home or starts the process all over to price another vehicle.

Throughout all of the above steps (or at various places in the application), the customer (also referred to as the user) may have access to expert help, which may be provided through live phone call or email.

It should be understood, of course, that the foregoing relates to exemplary embodiments of the invention and that modifications may be made without departing from the spirit and scope of the invention as set forth in the following claims.

The detailed description herein is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The examples presented herein are intended to illustrate potential and specific implementations of the example embodiments. It can be appreciated that the examples are intended primarily for purposes of illustration for those skilled in the art. No particular aspect or aspects of the examples is/are intended to limit the scope of the described example embodiments. The figures and descriptions of the example embodiments have been simplified to illustrate elements that are relevant for a clear understanding of the example embodiments, while eliminating, for purposes of clarity, other elements.

In general, it will be apparent to one of ordinary skill in the art that at least some of the example embodiments described herein may be implemented in many different example embodiments of software, firmware, and/or hardware. The software and firmware code may be executed by a processor or any other similar computing device. The software code or specialized control hardware that may be used to implement example embodiments is not limiting. For example, example embodiments described herein may be implemented in computer software using any suitable computer software language type, using, for example, conventional or object-oriented techniques. Such software may be stored on any type of suitable computer-readable medium or media, such as, for example, solid state memory (e.g., RAM or ROM), magnetic storage media, or optical storage media. The operation and behavior of the example embodiments may be described without specific reference to specific software code or specialized hardware components. The absence of such specific references is feasible, because it is clearly understood that artisans of ordinary skill would be able to design software and control hardware to implement the example embodiments based on the present description with no more than reasonable effort and without undue experimentation.

Moreover, the processes associated with the present example embodiments may be executed by programmable equipment, such as computers, computer systems, servers, server systems, database systems, and/or processors (e.g., the various systems and devices described herein). Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as memory chips (RAM or ROM), diskettes, compact discs (CDs), digital versatile discs (DVDs), optical disk drives, or hard disk drives. A computer-readable medium may also include memory storage that is physical, virtual, permanent, temporary, semi-permanent, and/or semi-temporary.

A “computer,” “computer system,” “server,” “processing device,” or “server system” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed example embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various example embodiments disclosed herein, a single component may be replaced by multiple components and multiple components may be replaced by a single component to perform a given function or functions. Except where such substitution would not be operative, such substitution is within the intended scope of the example embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer system may comprise one or more processors in communication with memory (e.g., RAM or ROM) via data bus. The data bus may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

While various example embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment. Reference to embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A customer computer device for facilitating the purchase of products, the device comprising:
at least one processor and operatively associated memory, the memory comprising instructions that, when executed by the at least one processor, cause the customer device to:
obtain a product identifier from an instance of a product, wherein the product identifier indicates a first instance of the product;
transmit the product identifier to a service provider system;
receive from the service provider system a rebated sales price for the first instance of the product, wherein the rebated sales price reflects an invoice price of the product, a deduction to the invoice price, and at least one rebate offered by the manufacturer of the product; and
provide the rebated sales price to a customer via a graphical user interface.

2. The customer computer device of claim 1, wherein the memory further comprises instructions that, when executed by the at least one processor, cause the customer device to, before receiving the rebated sales price, transmit to the service provider system a message indicating a location of the customer computer device.

3. The customer computer device of claim 1, wherein obtaining the product identifier from the first instance of the product comprises at least one of:
receiving the identifier manually from a customer.
capturing an image of at least a portion of the first instance;
capturing a bar code on the first instance; and
capturing a QR code.

4. The customer computer device of claim 1, wherein the memory further comprises instructions that, when executed by the at least one processor, cause the customer device to:
calculate a geographic location of the customer device;
transmit the geographic location of the customer device to the service provider system;
receive from the service provider system indications of a plurality of dealers at about the geographic location;
provide the indications of the plurality of dealers to the customer via the graphical user interface;
receive, from the customer and via the graphical user interface, a selection of one of the plurality of dealers; and
transmit the selection to the service provider system.

5. The customer computer device of claim 1, wherein the memory further comprises instructions that, when executed by the at least one processor, cause the customer device to:
receive from the service provider system at least one set of financing terms from a finance provider for financing a purchase of the first instance of the product; and
provide the at least one set of financing terms to the customer via the graphical user interface.

6. The customer computer device of claim 1, wherein the memory further comprises instructions that, when executed by the at least one processor, cause the customer device to:
receive from the customer via the graphical user interface, an indication of a type of the product;
transmit the type of the product to the service provider system;
receive from the service provider system data describing the type of the product; and
provide the data describing the type of the product to the customer via the graphical user interface.

7. The customer computer device of claim 6, wherein the data describing the type of product comprises at least one of specifications of the type of product; images of the type of product; and dealers with the type of product in stock.

8. A system for facilitating the purchase of products, the system comprising:
a computer system, the computer system comprising at least one processor and operatively associated memory, the memory comprising instructions that, when executed by the at least one processor, cause the computer device to:
receive from a customer, a product identifier indicating a first instance of a product;
retrieve, using the first instance identifier, an invoice price for the first instance of the product;
apply an offset to the invoice price to generate a sales price for the first instance of the product;
receive from a third party, rebate information describing at least one rebate offered by the manufacturer of the product;
apply the at least one rebate to the sales price to generate a rebated sales price; and
provide the rebated sales price to the customer.

9. The system of claim 8, wherein the memory further comprises instructions that, when executed by the at least one processor, cause the computer system to:
receive from the customer an indication of whether the at least one rebate applies to a purchase of the first instance of the product by the customer.

10. The system of claim 8, wherein the retrieving the invoice price comprises retrieving the invoice price from a dealer computer system associated with a dealer.

11. The system of claim 8, wherein the third party is selected from the group consisting of a manufacturer of the product and a third party pricing source.

12. The system of claim 8, wherein the memory further comprises instructions that, when executed by the at least one processor, cause the computer system to, before receiving the first instance identifier:
receive, by the computer system, location information from the customer, the location information indicating a customer location;
match, by the computer system, the customer.location to at least one product dealer having a product dealer location at about the customer location;
receive, by the computer system and from the customer, a selection of a product dealer from the at least one product dealer.

13. The system of claim 8, wherein the memory further comprises instructions that, when executed by the at least one processor, cause the computer system to, before providing the rebated sales price to the customer, check-in the customer at a dealer stocking the product instance, wherein the check-in comprises:
receiving, by the computer system, location information from the customer, the location information indicating a customer location; and
comparing the location information to a location of the dealer.

14. The system of claim 13, wherein the memory further comprises instructions that, when executed by the at least one processor, cause the computer system to:
receive from the customer a request for information about the product; and
provide the customer the requested information about the product, wherein the request for information about the product comprises the location information.

15. The system of claim 8, wherein the memory further comprises instructions that, when executed by the at least one processor, cause the computer system to:
provide the rebated sales price to a finance provider system;
receive from the finance provider system financing terms for the customer, the financing terms including a monthly payment;
provide the financing terms to the customer.

16. The system of claim 15, wherein the memory further comprises instructions that, when executed by the at least one processor, cause the computer system to:
receive credit information from the customer; and
provide the credit information to the finance provider.

17. The system of claim 16, wherein the credit information comprises an authorization for at least one of the computer system and the finance provider to request at least one credit score for the customer.

18. The system of claim 8, wherein the memory further comprises instructions that, when executed by the at least one processor, cause the computer system to:
provide the rebated sales price to a plurality of finance providers; and
receive financing terms for the customer from each of the plurality of finance providers, wherein the financing terms for the customer from each of the plurality of finance providers comprise a monthly payment.

19. The system of claim 18, wherein the memory further comprises instructions that, when executed by the at least one processor, cause the computer system to select the finance provider from the plurality of finance provider that provided the lowest monthly payment for the customer.

20. The system of claim 18, further comprising providing the customer with the financing terms from at least a portion of the plurality of finance providers.

21. A method for facilitating the purchase of products, the method comprising:
receiving, by a computer system and from a customer, a product identifier indicating a first instance of a product, wherein the computer system comprises at least one processor and operatively associated memory;
retrieving, by the computer system and using the first instance identifier, an invoice price for the first instance of the product;
applying, by the computer system, an offset to the invoice price to generate a sales price for the first instance of the product;
receiving, by the computer system and from a third party, rebate information describing at least one rebate offered by the manufacturer of the product;
applying, by the computer system, the at least one rebate to the sales price to generate a rebated sales price; and
providing, by the computer system, the rebated sales price to the customer.

22. A computer-implemented system for facilitating communication between dealers and potential customers, the system comprising:
at least one processor and operatively associated memory, wherein the memory comprises instructions that, when executed by the at least one processor, cause the at least one processor to:
from each of a plurality of customer devices, receive at least one information query regarding a product;
from each of the plurality of customer devices, receive location information, wherein the location information for each customer device indicates a geographic location of the customer device;
provide the location information from each of the plurality of customer devices and the product from the query of each of the customer devices to a dealer via a dealer interface accessible by a dealer computer device;
receive from the dealer via the dealer computer device a message to be provided to a first customer device selected from the plurality of customer devices; and
transmit the message to the first customer device.

23. The system of claim 22, wherein the message indicates an incentive on a sale of an instance of the product to a customer associated with the customer device.

24. The system of claim 22, wherein the memory comprises instructions that, when executed by the at least one processor, cause the at least one processor to select the dealer from a plurality of dealers considering:
whether the dealer sells the product; and
a proximity between a location of the dealer and the geographic location of the customer device.

25. The system of claim 22, wherein providing the location information from each of the plurality of customer devices to the dealer comprises providing the dealer system with a graphical user interface comprising a graphical map, and wherein the geographic location of each of the plurality of customer devices is indicated on graphical map by a customer device indication.

26. The system of claim 22, wherein the memory comprises instructions that, when executed by the at least one processor, cause the at least one processor to:
receive from the dealer system and through the graphical user interface an indication of a marker associated with the first customer device;
provide the dealer system with a message interface for receiving the message to be provided to the first customer device.

27. A computer-implemented method for facilitating communication between dealers and potential customers, the method comprising:
from each of a plurality of customer devices, receiving by a computer system at least one information query regarding a product, wherein the computer system comprises at least one processor and associated memory;
from each of the plurality of customer devices, receiving by the computer system location information, wherein the location information for each customer device indicates a geographic location of the customer device;
providing the location information from each of the plurality of customer devices and the product from the query of each of the customer devices by the computer system to a dealer via a dealer interface accessible by a dealer computer device;
receiving, by the computer system and from the dealer via the dealer computer device a message to be provided to a first customer device selected from the plurality of customer devices; and
transmitting, by the computer system, the message to the first customer device.
